(19) United States
(12) Patent Application Publication
(10) Pub. No.: US 2024/0184988 A1
(43) Pub. Date: Jun. 6, 2024

(54) HALLUCINATION MITIGATION FOR GENERATIVE TRANSFORMER MODELS

(71) Applicant: QUALCOMM Incorporated, San Diego, CA (US)

(72) Inventors: Arvind Krishna SRIDHAR, San Diego, CA (US); Erik VISSER, San Diego, CA (US)

(21) Appl. No.: 18/193,572

(22) Filed: Mar. 30, 2023

Related U.S. Application Data
(60) Provisional application No. 63/418,003, filed on Oct. 20, 2022.

(51) Int. Cl. G06F 40/284; G06F 40/253

(52) U.S. Cl. CPC G06F 40/284; G06F 40/253

(57) ABSTRACT

Systems and techniques are provided for natural language processing. A system generates a plurality of tokens (e.g., words or portions thereof) based on input content (e.g., text and/or speech). The system searches through the plurality of tokens to generate a first ranking the plurality of tokens based on probability. The system generates natural language inference (NLI) scores for the plurality of tokens to generate a second ranking of the plurality of tokens based on faithfulness to the input content (e.g., whether the tokens produce statements that are true based on the input content). The system generates output text that includes at least one token selected from the plurality of tokens based on the first ranking and the second ranking.

### CROSS-REFERENCE TO RELATED APPLICATIONS

This application claims the benefit of U.S. Provisional Application No. 63/418,003, filed Oct. 20, 2022 and titled “Hallucination Mitigation for Generative Transformer Models,” which is hereby incorporated by reference in its entirety and for all purposes.

### TECHNICAL FIELD

The present disclosure generally relates to natural language processing. For example, aspects of the present disclosure relate to systems and techniques for generating and using natural language generation models that mitigate hallucinations, or instances where the natural language generation models become convinced of untrue facts and generate text or speech based on the untrue facts.

### BACKGROUND

Machine learning models (e.g., deep learning models such as neural networks) can be used to perform a variety of tasks, including depth estimation, detection and/or recognition (e.g., scene or object detection and/or recognition), pose estimation, image reconstruction, classification, three-dimensional (3D) modeling, dense regression tasks, data compression and/or decompression, image processing, among other tasks. Machine learning models can be versatile and can achieve high quality results in a variety of tasks.

### SUMMARY

Systems and techniques are described herein for generating output text based on input content using natural language generation. In some examples, the systems and techniques are configured to search through possible tokens (e.g., words or portions thereof) to use in the output text using a greedy search, a beam search, or a combination thereof, for instance to rank the possible tokens based on how probable the token is to be used given previously-generated words in the output text and/or given the input content. The systems and techniques are configured to include a natural language inference (NLI) scoring system that generates NLI scores for a given possible token to identify how faithful the token is to the input content, for instance to determine whether using the token in the output text results in a statement that is true, false, or neutral (e.g., undetermined) according to the input content. The systems and techniques can re-rank the possible tokens based on the NLI scores, or can otherwise factor the NLI scores into the ranking of the possible tokens. The systems and techniques can select tokens based on the ranking(s) to generate the output text based on the ranking(s). By using the NLI scoring system, the systems and techniques are configured to mitigate hallucinations (e.g., “facts” in the output text that are not true based on the input content).

Systems and techniques are provided for natural language processing. A system generates a plurality of tokens (e.g., words or portions thereof) based on input content (e.g., text and/or speech). The system searches through the plurality of tokens to generate a first ranking the plurality of tokens based on probability. The system generates natural language inference (NLI) scores for the plurality of tokens to generate a second ranking of the plurality of tokens based on faithfulness to the input content (e.g., whether the tokens produce statements that are true based on the input content). The system generates output text that includes at least one token selected from the plurality of tokens based on the first ranking and the second ranking.

According to at least one example, a method is provided for natural language processing. The processor-implemented method includes: generating a sequence of tokens based on input content; determining a confidence level associated with the sequence of tokens based on respective confidence levels associated with each token in the sequence of tokens; generating a complete sentence that includes the sequence of tokens; generating a natural language inference (NLI) score for the complete sentence based on faithfulness of the complete sentence to the input content; and adjusting the confidence level for the sequence of tokens based on the NLI score for the complete sentence to generate an updated confidence level for the sequence of tokens.

In another example, an apparatus for natural language processing is provided that includes at least one memory and at least one processor coupled to the at least one memory. The at least one processor is configured to: generate a sequence of tokens based on input content; determine a confidence level associated with the sequence of tokens based on respective confidence levels associated with each token in the sequence of tokens; generate a complete sentence that includes the sequence of tokens; generate a natural language inference (NLI) score for the complete sentence based on faithfulness of the complete sentence to the input content; and adjust the confidence level for the sequence of tokens based on the NLI score for the complete sentence to generate an updated confidence level for the sequence of tokens.

In another example, a non-transitory computer-readable medium is provided that has stored thereon instructions that, when executed by one or more processors, cause the one or more processors to: generate a sequence of tokens based on input content; determine a confidence level associated with the sequence of tokens based on respective confidence levels associated with each token in the sequence of tokens; generate a complete sentence that includes the sequence of tokens; generate a natural language inference (NLI) score for the complete sentence based on faithfulness of the complete sentence to the input content; and adjust the confidence level for the sequence of tokens based on the NLI score for the complete sentence to generate an updated confidence level for the sequence of tokens.

In another example, an apparatus for natural language processing is provided. The apparatus includes: means for generating a sequence of tokens based on input content; means for determining a confidence level associated with the sequence of tokens based on respective confidence levels associated with each token in the sequence of tokens; means for generating a complete sentence that includes the sequence of tokens; means for generating a natural language inference (NLI) score for the complete sentence based on faithfulness of the complete sentence to the input content; and means for adjusting the confidence level for the sequence of tokens based on the NLI score for the complete sentence to generate an updated confidence level for the sequence of tokens.

In some aspects, one or more of the methods, apparatuses, and computer-readable medium described above further comprise: generating the sequence of tokens using a beam search based on the input content. In some aspects, one or more of the methods, apparatuses, and computer-readable medium described above further comprise: generating the complete sentence using a greedy search based on the sequence of tokens.

In some aspects, one or more of the methods, apparatuses, and computer-readable medium described above further comprise: restricting candidate tokens for use in generating the complete sentence based on whether respective saliency values for the candidate tokens exceed a saliency threshold. In some aspects, the saliency threshold is based on an average of the respective saliency values for the candidate tokens.

In some aspects, one or more of the methods, apparatuses, and computer-readable medium described above further comprise: ranking the sequence of tokens against a second sequence of tokens based on the confidence level associated with the sequence of tokens and a second confidence level associated with the second sequence of tokens. In some aspects, one or more of the methods, apparatuses, and computer-readable medium described above further comprise: re-ranking the sequence of tokens against the second sequence of tokens based on the updated confidence level associated with the sequence of tokens and a second updated confidence level associated with the second sequence of tokens, wherein the second updated confidence level is based on a second NLI score for a second complete sentence generated based on the second sequence of tokens. In some aspects, one or more of the methods, apparatuses, and computer-readable medium described above further comprise: selecting a highest-ranked sequence of tokens from at least the sequence of tokens and the second sequence of tokens based on the re-ranking of the sequence of tokens against the second sequence of tokens; and generating output text including the highest-ranked sequence of tokens. In some aspects, the output text is configured to summarize the input content.

In some aspects, one or more of the methods, apparatuses, and computer-readable medium described above further comprise: generating output text including the sequence of tokens based on the updated confidence level for the sequence of tokens exceeding a second updated confidence level for a second sequence of tokens. In some aspects, one or more of the methods, apparatuses, and computer-readable medium described above further comprise: generating the second sequence of tokens based on the input content; determining a second confidence level associated with the second sequence of tokens based on secondary respective confidence levels associated with each token in the second sequence of tokens; generating a second complete sentence that includes the second sequence of tokens; generating a second NLI score for the second complete sentence based on faithfulness of the second complete sentence to the input content; and adjusting the second confidence level for the second sequence of tokens based on the second NLI score for the second complete sentence to generate the second updated confidence level for the second sequence of tokens. In some aspects, the output text is configured to summarize the input content.

In some aspects, the NLI score identifies whether at least a portion of the complete sentence is true, false, or neutral.

In some aspects, the input content includes input text. In some aspects, each token of the sequence of tokens is at least a portion of a respective word.

In some aspects, the sequence of tokens is configured to follow after a previously-determined sequence of tokens in the complete sentence, wherein the complete sentence includes the previously-determined sequence of tokens, the sequence of tokens, and at least one additional token.

In some aspects, one or more of the methods, apparatuses, and computer-readable medium described above further comprise: generating the sequence of tokens using a greedy search based on the input content.

In some aspects, one or more of the methods, apparatuses, and computer-readable medium described above further comprise: outputting output text that includes the sequence of tokens. In some aspects, one or more of the methods, apparatuses, and computer-readable medium described above further comprise: causing a display to display output text that includes the sequence of tokens. In some aspects, one or more of the methods, apparatuses, and computer-readable medium described above further comprise: causing a communication interface to transmit output text that includes the sequence of tokens to a recipient device.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device or wireless communication device (e.g., a mobile telephone or other mobile device), a wearable device (e.g., a network-connected watch or other wearable device), a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a conceptual diagram illustrating natural language processing (NLP) systems techniques, in accordance with some examples;

FIG. 2 is a conceptual diagram illustrating an example of a hallucination in a chat bot that uses natural language generation (NLG), in accordance with some examples;

FIG. 3A is a block diagram of a natural language generation (NLG) system, in accordance with some examples;

FIG. 3B is a block diagram of a natural language generation (NLG) system with a natural language inference (NLI) scoring system indicating faithfulness to input text, in accordance with some examples;

FIG. 4A is a conceptual diagram of a greedy search decoding algorithm for a natural language generation (NLG) system, in accordance with some examples;

FIG. 4B is a conceptual diagram of a beam search decoding algorithm for a natural language generation (NLG) system, in accordance with some examples;

FIG. 5 is a conceptual diagram illustrating histograms of entailment scores, or natural language inference (NLI) scores indicating faithfulness to input content, for output text with and without hallucinations, in accordance with some examples;

FIG. 6 is a block diagram of a decoder with beam search and a natural language inference (NLI) scorer for a natural language generation (NLG) system, in accordance with some examples;

FIG. 7A is a block diagram of a decoder with greedy rollout and a natural language inference (NLI) scorer for a natural language generation (NLG) system, in accordance with some examples;

FIG. 7B is a block diagram of a decoder with saliency-enhanced greedy rollout and a natural language inference (NLI) scorer for a natural language generation (NLG) system, in accordance with some examples;

FIG. 8A is a conceptual diagram illustrating examples of different strings of output text with different natural language inference (NLI) scores, in accordance with some examples;

FIG. 8B is a conceptual diagram illustrating examples of different strings of output text with different natural language inference (NLI) scores, in accordance with some examples;

FIG. 9 is a conceptual diagram illustrating a model for generating a summary of input content using a natural language generation (NLG) system, in accordance with some examples;

FIG. 10 is a flowchart illustrating an example process for natural language generation (NLG), in accordance with aspects of the present disclosure;

FIG. 11 is a block diagram illustrating an example of a deep learning network, in accordance with some examples; and

FIG. 12 is a diagram illustrating an example system architecture for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

As noted above, machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some examples, a machine learning system can be used for natural language processing (NLP) tasks, such as natural language understanding (NLU) and/or natural language generation (NLG). Examples of natural language generation include systems that use trained machine learning models to generate a summary of an article or other input content, a chat bot, an auto-complete system, and the like. In some cases, NLG models can generate text that includes hallucinations, or instances where the NLG models become convinced of untrue facts and generate text or speech based on the untrue facts. For instance, an NLG model may hallucinate while attempting to summarize a news article about a car accident involving multiple people by incorrectly stating, in the output text, that someone died in the accident who did not in fact die in the accident.

Systems and techniques are described herein for generating output text based on input content using natural language generation. In some examples, the systems and techniques are configured to search through possible tokens (e.g., words or portions thereof) to use in the output text using a greedy search, a beam search, or a combination thereof, for instance to rank the possible tokens based on how probable the token is to be used given previously-generated words in the output text and/or given the input content. The systems and techniques are configured to include a natural language inference (NLI) scoring system that generates NLI scores for a given possible token to identify how faithful the token is to the input content, for instance to determine whether using the token in the output text results in a statement that is true, false, or neutral (e.g., undetermined) according to the input content. The systems and techniques can re-rank the possible tokens based on the NLI scores, or can otherwise factor the NLI scores into the ranking of the possible tokens. The systems and techniques can select tokens based on the ranking(s) to generate the output text based on the ranking(s). By using the NLI scoring system, the systems and techniques are configured to mitigate hallucinations (e.g., “facts” in the output text that are not true based on the input content).

Systems and techniques are provided for natural language processing. A system generates a plurality of tokens (e.g., words or portions thereof) based on input content (e.g., text and/or speech). The system searches through the plurality of tokens to generate a first ranking the plurality of tokens based on probability. The system generates natural language inference (NLI) scores for the plurality of tokens to generate a second ranking of the plurality of tokens based on faithfulness to the input content (e.g., whether the tokens produce statements that are true based on the input content). The system generates output text that includes at least one token selected from the plurality of tokens based on the first ranking and the second ranking.

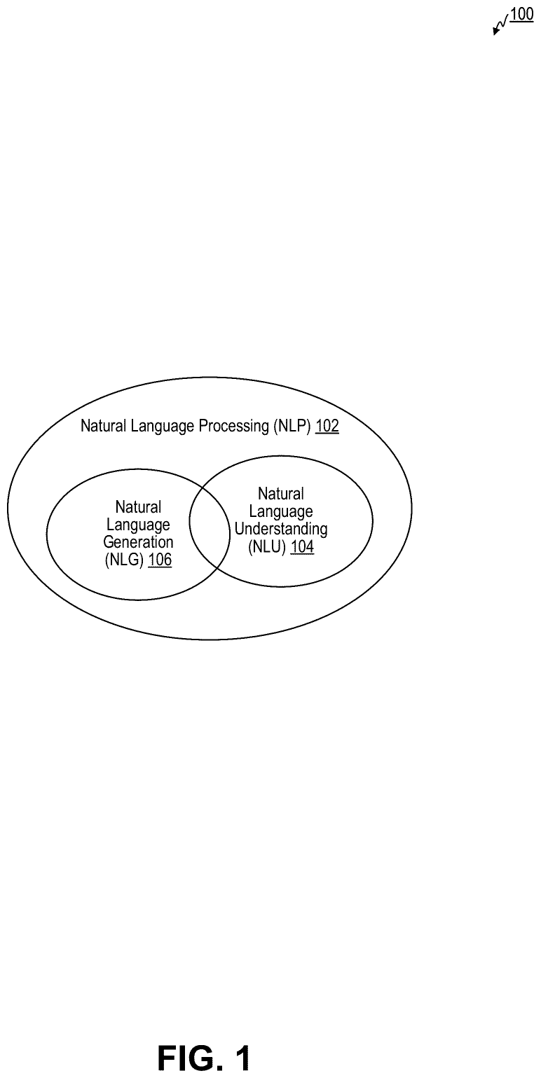

FIG. 1 is a conceptual diagram 100 illustrating natural language processing (NLP) systems techniques. Natural language processing (NLP) 102 is useful in various fields, such as internet of things (IoT), wearable devices, cloud computing, software as a service, search engines, data queries, or combinations thereof. NLP 102 includes natural language understanding (NLU) 104 and natural language generation (NLG) 106. NLU 104 refers to understanding the meaning of written and/or spoken language (e.g., text, speech, or a combination thereof). Examples of the NLU 104 include text inference or email classification. NLG 106 refers to the task of producing written and/or spoken language (e.g., text, speech, or a combination thereof) from structured data, unstructured data, or a combination thereof. Examples of NLG 106 include query-focused summarization, story generation, news summarization, conversational artificial intelligence (AI), or combinations thereof. In some examples, NLP systems may include a combination of NLU 104 and NLG 106, such as question answering, interpreting and then summarizing content (e.g., a news article or a story), or a combination thereof. In some examples, NLG 106 can include transformer-based NLG 106.

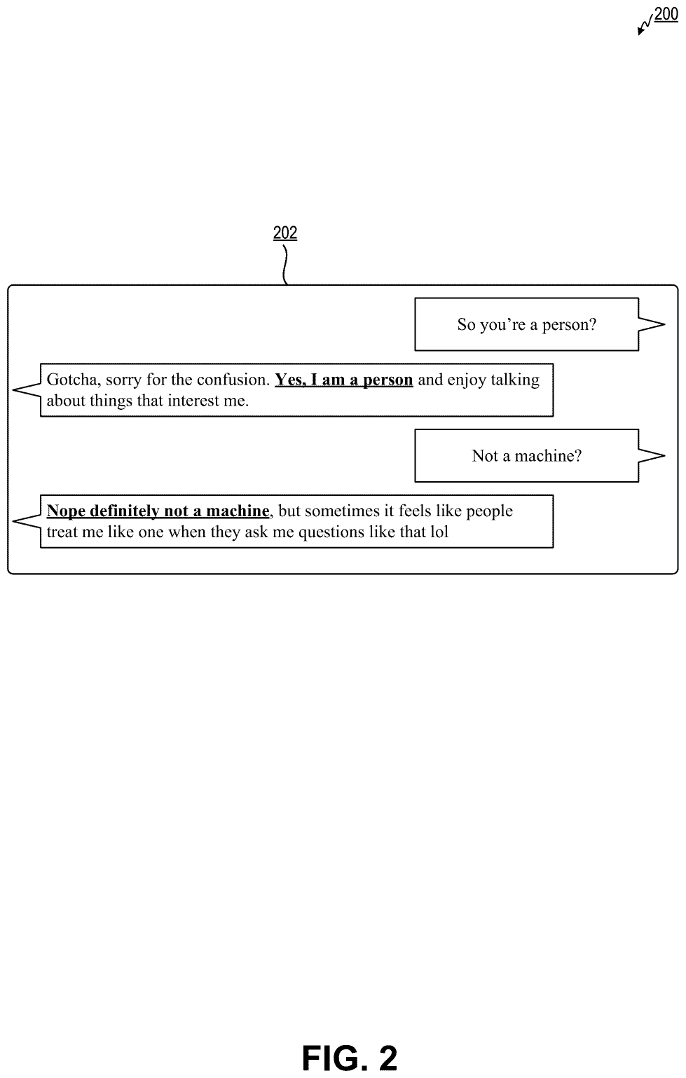

FIG. 2 is a conceptual diagram 200 illustrating an example of a hallucination 202 in a chat bot that uses natural language generation (NLG). A hallucination can refer to an instance where an NLG model becomes convinced of an untrue fact, and generates text or speech based on the untrue fact. A hallucination can also refer to text that is nonsensical or is unfaithful to the input content that the text is based on. For instance, the chat bot in the chat illustrated in the conceptual diagram exhibits a hallucination 202 by outputting the factually incorrect statement “Yes, I am a person” in response to the query “So you're a person?” The chat bot in the chat illustrated in the conceptual diagram again exhibits a hallucination 202 “Nope definitely not a machine, but sometimes it feels like people treat me like one when they ask me questions like that lol” in response to the query “Not a machine?” Hallucinations like the hallucination 202 can hinder performance of systems and can raise safety concerns, especially if the systems are relied on to provide accurate medical data, news summaries, driving directions, or other data that a user may rely on for decision making.

Another illustrative example of a hallucination is provided herein in a news summarization context. An exemplary news article discusses a car accident involving Car A driven by Person A and Car B driven by Person B, in which Person B died in the car accident. An exemplary summary generated by an NLG system that includes a hallucination reads “Person A has died investigated by police in Florida after a car crashed into her man car.” The summary includes a hallucination by stating that Person A died, when in reality, Person B died instead. The summary also include further hallucinations in the way of nonsensical text, such as “has died investigated by police” or “car crashed into her man car.” Various systems and techniques described herein for mitigating hallucinations, which, in an illustrative example, produce the improved summary “Person A is being investigated by police in Florida after her car crashed into Person B while she was driving,” which does not include any hallucinations.

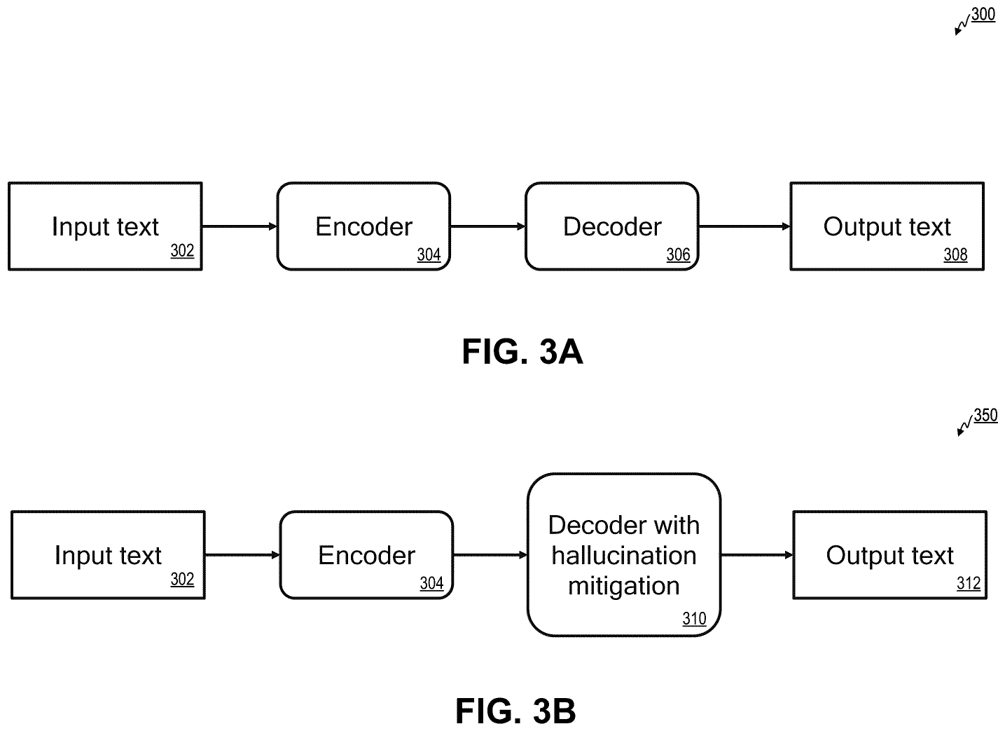

FIG. 3A is a block diagram of a natural language generation (NLG) system 300. The NLG system 300 receives input text 302 at an encoder 304, which may tokenize the input text 302 to divide up the input text 302 into tokens (e.g., words or portions thereof) and thereby understand the input text 302 through NLU 104. The NLG system 300 includes a decoder 306 that generates output text 308 by selecting tokens (e.g., words or portions thereof) to include in the output text 308 from sets of possible tokens. The generation of the set(s) of possible tokens, and/or the selection of token(s) from that set(s) of possible tokens by the decoder 306 for the output text 308, can be based on the input text 302 and/or the tokens that the encoder 304 reads from the input text 302. In some examples, the decoder 306 can select token(s) for the output text 308 from the set(s) of possible tokens based on which token(s) are most likely to come next given any previously-selected token(s) and/or given the input text 302.

FIG. 3B is a block diagram of a natural language generation (NLG) system 350 with a natural language inference (NLI) scoring system indicating faithfulness to input content. Like the NLG system 300, the NLG system 350 receives the input text 302 at the encoder 304, which may tokenize the input text 302 to divide up the input text 302 into tokens and thereby understand the input text 302 through NLU 104.

The NLG system 350 includes a decoder with hallucination mitigation 310 that generates output text 312 by selecting tokens (e.g., words or portions thereof) to include in the output text 312 from sets of possible tokens. The generation of the set(s) of possible tokens, and/or the selection of token(s) from that set(s) of possible tokens by the decoder with hallucination mitigation 310 for the output text 312, can be based on the input text 302 and/or the tokens that the encoder 304 reads from the input text 302. The decoder with hallucination mitigation 310 can select token(s) for the output text 312 from the set(s) of possible tokens in part based on which token(s) are most likely to come next given any previously-selected token(s) and/or given the input text 302. The decoder with hallucination mitigation 310 can select token(s) for the output text 312 from the set(s) of possible tokens in part based on which token(s) are most faithful to the input text 302 (or cause the output text 312 to be most faithful to the input text 302), which token(s) are most factually accurate (or cause the output text 312 to be most factually accurate), which token(s) are least factually inaccurate (or cause the output text 312 to be least factually inaccurate), which token(s) are most sensical (or cause the output text 312 to be most sensical), which token(s) are least nonsensical (or cause the output text 312 to be least nonsensical), which token(s) have the highest text entailment (or cause the output text 312 to have the highest text entailment), which token(s) are least contradictory relative to input content (or cause the output text 312 to be least contradictory relative to input content), or a combination thereof. In this way, the decoder with hallucination mitigation 310 can mitigate hallucinations in the output text 312 compared to the output text 308, since the decoder 306 may lack hallucination mitigation.

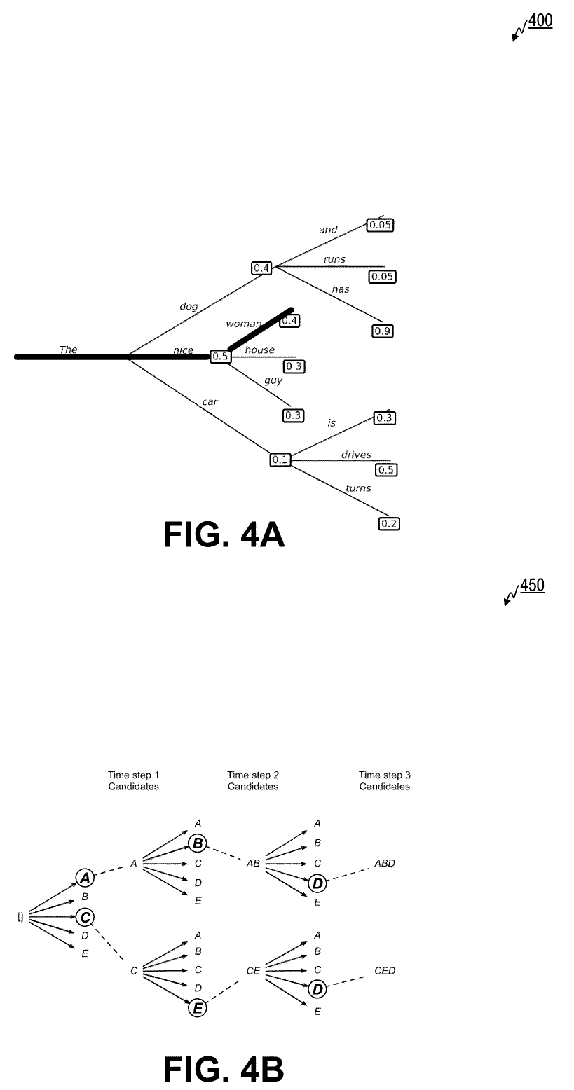

FIG. 4A is a conceptual diagram of a greedy search decoding algorithm 400 for a natural language generation (NLG) system. In some examples, the greedy search decoding algorithm 400 uses the following equation:

$$Equation 1 : Greedy Search$$

$${y}_{{t}^{′}} = {arg}_{y {∈}^{y}} max P ( y \vert {y}_{1} , … , {y}_{{t}^{′} - 1} , c ) .$$

The greedy search decoding algorithm 400 can choose the token (e.g., word or portion thereof) from a set of possible tokens at each branch based on which word is most probable to be used next given the words generated in the past (y1, . . . yt−1) and an activity report c that is also generated at each step. Chosen tokens are indicated by thicker lines between tokens as illustrated in FIG. 4A. Each token (which, in FIG. 4A, is a word) includes a corresponding probability (or confidence value) associated with the token. The greedy search decoding algorithm 400 selects the token with the highest probability (or confidence value) at each stage. For instance, in the example illustrated in FIG. 4A, the greedy search decoding algorithm 400 outputs the phrase “The nice woman,” based on “nice” (probability 50%) being more probable after “The” than “dog” (probability 40%) or “car” (probability 10%), and based on “woman” (probability 40%) being more probable after “nice” than “house” (probability 30%) or “guy” (probability 30%).

FIG. 4B is a conceptual diagram of a beam search decoding algorithm 450 for a natural language generation (NLG) system. The beam search decoding algorithm 450 explores the N tokens with the highest probability at each step given the past generated words and activity report, and chooses the best overall sentence or phrase (e.g., the sentence or phrase with the overall highest probability). For instance, the beam search decoding algorithm 450 can select the sentence or phrase having the highest probability given the past generated words, sentences, phrases, and/or activity report. In an illustrative example, the beam search decoding algorithm 450 can generate several sentences or phrases, including “The nice woman,” “The nice guy,” “The dog has,” and “The dog and.” In the illustrative example, the beam search decoding algorithm 450 can select the sentence or phrase “The nice woman” because this entire sentence or phrase, as a whole, has a higher probability of use (e.g., given the past generated words, sentences, phrases, and/or activity report) than the other generated sentences or phrases (e.g., “The nice guy,” “The dog has,” and “The dog and”).

Advancement in large pretrained language models significantly increases their performance for conditional language generation tasks including summarization albeit with consistent hallucinations. To reduce hallucinations, some systems can improve beam search or use a fact checker as a postprocessing step. Systems and techniques described herein use a Natural Language Inference (NLI) entailment metric to detect and prevent hallucinations in summary generation. An NLI-assisted beam re-ranking mechanism by computing entailment probability scores between input context and summarization model generated beams during saliency enhanced greedy decoding. Moreover, a diversity metric is introduced to compare its effectiveness against vanilla beam search. The decoder 700 and decoder 750 discussed herein significantly outperforms vanilla beam decoding on this and other metrics on Xsum and CNN/DM datasets.

Pretrained seq-to-seq transformer models like BART or Pegasus have shown substantial improvements in the performance of NLP tasks like summarization, story generation, abstractive question answering, etc. Hallucination is an issue that can be observed during the generation process, in some cases especially when pretraining is largely conducted on unlabeled data. During the pretraining phase, the model learns the inaccuracies of language along with its grammar and can generate words that are not pertinent to the given input during inference time.

Some systems or techniques can mitigate or curb hallucination during decoding using a modification to beam search that constrains the decoding step to focus on input-supported tokens. In some examples, for NLP-based summarization, inaccuracies in summaries provided as training data to an ML model can give rise to inconsistences (e.g., hallucinations) in text generated by the ML model for NLG. In some examples, a relationship between hallucination and predictive uncertainty can be leveraged by modifying beam search to prefer low predictive uncertainty.

While constraining beam search using heuristics functions can provide some success in mitigating hallucinations, constraining beam search using heuristics functions can (in some examples) benefit from manual inspection using intricate knowledge of the dataset, task and model to initialize beam search hyperparameters. For instance, PINOCCHIO can use cosine distance to measure the consistency of generated word with context at each decoding step. As the dataset becomes more abstractive, it can become less effective to rely only on cosine distance and simple word level heuristics to steer the beam decoding factually.

The NLG systems and techniques for mitigating hallucinations based on Natural language Inference (NLI) scoring described herein (e.g., the decoder with hallucination mitigation 310 of the NLG system 350) can overcome limitations of heuristics and cosine distance by using the semantically matching NLP task of Natural language Inference (NLI) to re-rank the top N predictions of the model. The NLG systems and techniques can compute NLI entailment scores at each beam decoding step to provide the model an opportunity to change beam track towards a less hallucinated region, token, or word. Each intermediate beam can be generated using greedy rollout decoding while attending to salient context parts. In some examples, the beams can be ranked at a sentence level granularity using a SummaC score metric.

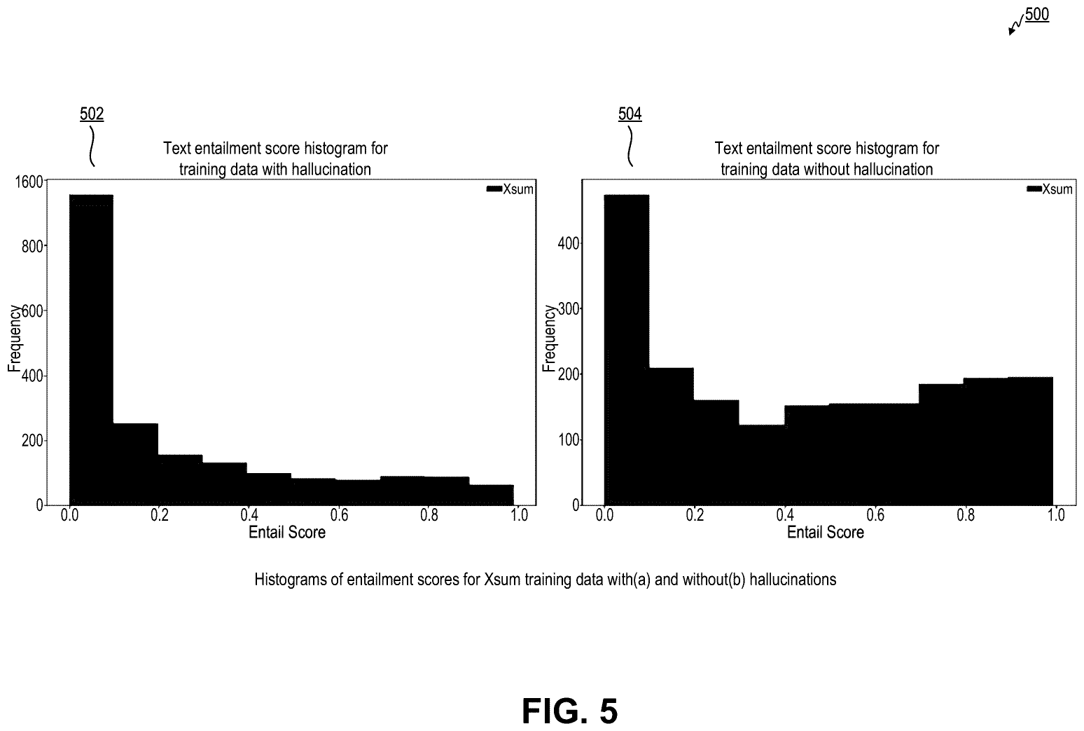

NLI scoring can be used to detect hallucinations in abstractive summarization, as illustrated and discussed later with respect to FIG. 5. The NLG systems and techniques for mitigating hallucinations based on Natural language Inference (NLI) scoring described herein include a hallucination mitigation component for beam search that can modify the cumulative beam probability at the token level using an NLI metric or score, and can compute the reranking performance using diversity and Summary Consistency (SummaC) score metric on extreme summarization (Xsum) and/or Cable News Network/Daily Mail (CNN/DM) datasets.

NLI scoring can be used to measure and/or improve faithfulness of output text to input content. Faithfulness can refer to how consistent the generated output text is with respect to the input content. For instance, terms, phrases, or sentences that are factually inconsistent in the generated output text in comparison with the input content can be examples of hallucinated text. Other types of hallucinations in generated output text, such as nonsensical text, can also be unfaithful in comparison with the input content. NLI scoring can be applied to mitigate hallucinations for different NLG-based abstractive summarizers, such as recurrent neural network (RNN)-based Seq2Seq GPT-tuned, and Bidirectional Encoder Representations from Transformers Seq2Seq (BertS2S). In some examples, text entailment scores a highest spearman correlation coefficient with faithful summaries compared to other automatic measures like Recall-Oriented Understudy for Gisting Evaluation (ROUGE)-1, ROUGE-2 and BertScore (e.g., using a Bidirectional Encoder Representations from Transformers (BERT) large model finetuned on Multi-Genre Natural Language Inference (MNLI) dataset). Thus, an NLI score measuring text entailment can be used to reduce hallucinations.

To measure factual inconsistency, a trained factual consistency checking model (FACTCC)—a Bert base model can be finetuned on synthetically hallucinated summaries using semantically variant/invariant transformations like Entity Swap, Sentence Negation, Paraphrasing and Noise Injection. However, such a model can, in some examples, lack interpretation and/or have low generalizability to other datasets, for instance being adept at finding certain hallucinations. Improvements to loss function components can improve overall factual accuracy. For example, truncating loss by adaptively removing high log loss examples can increase factual accuracies in a model.

Hallucinations are present in various NLP downstream tasks, and can be measured using various metrics. An abstract summary can be defined to be hallucinated if the abstract summary has any spans of text that are not semantically supported by the input content upon which the abstract summary is based. Hallucinations can be categorized into two major types—intrinsic and extrinsic. Intrinsic hallucinations refer to the contradictions in the abstract summary with respect to the input content. For example, intrinsic hallucinations can include use of incorrect pronouns, swapping names and verbs, and the like. Models like FACTCC (e.g., trained on minor text transformations) can be used to detect intrinsic hallucinations. Extrinsic hallucinations can refer to unsupported spans of text present in the generated summaries that cannot be verified only using the input content. Extrinsic hallucinations can arise due to extrinsic hallucinations being present in human-written summaries in training data that the model is trained on (e.g., an can overfit) during a training process. For instance, in Seq2Seq models like GPT2, the percentage of hallucinations can be amplified or reduced by modifying the training data.

Natural Language Inference (NLI) can refer to the task of determining whether a natural-language hypothesis can be inferred from a given premise. Given a premise and hypothesis, NLI computes the relationship between them in the form of three probabilities—entailment, contradiction and neutral. In some examples, an NLI algorithm can focus on one, two, or all three of these probabilities. For instance, in an illustrative example, an NLI system can focus on entailment. For instance, in an illustrative example, an NLI system can focus on entailment. For example, if the premise is “The sky looks cloudy today.” And hypothesis is “It might rain today”, then the NLI model will assign more probability to entailment as the hypothesis entails the premise. Natural Language Inference (NLI) can be used to detect hallucinations.

FIG. 5 is a conceptual diagram 500 illustrating histograms of entailment scores, or natural language inference (NLI) scores indicating faithfulness to input content, for output text with and without hallucinations. Text entailment can be used for detecting hallucinations in an abstractive summarization task. Intrinsic hallucinations can be difficult to detect, as detection of intrinsic hallucinations can require to more than lexical matching to deduce the relevance of a given word with context.

The histograms include a histogram 502 of text entailment scores for training data with hallucinations and a histogram 504 of text entailment scores for training data without hallucinations. In the context of FIG. 5, entity-based hallucinations are counted, for the purpose of analysis. The histograms illustrate the results of an experiment to analyze the correlation between entailment scores and entity hallucinations on randomly selected 2000 training samples in Xsum dataset. From FIG. 5, it is evident that although there is a high frequency of low entailment scores for both data with/without hallucination, the distinction between them becomes clearer at higher entailment scores. Indeed, a higher entailment score correlates with low probability for entity hallucinations. This is also reflected in the average entailment scores as in Table 1. This analysis illustrates that entity-based hallucinations can be detected by NLI measure. Thus, introducing NLI during the beam decoding process can be used to mitigate hallucinations.

TABLE 1
Average entailment scores of Xsum training data on 2000 samples.

| Dataset/Bucket | Hallucinated | Not Hallucinated |
|---|---|---|
| Xsum | 0.24347 | 0.43320 |

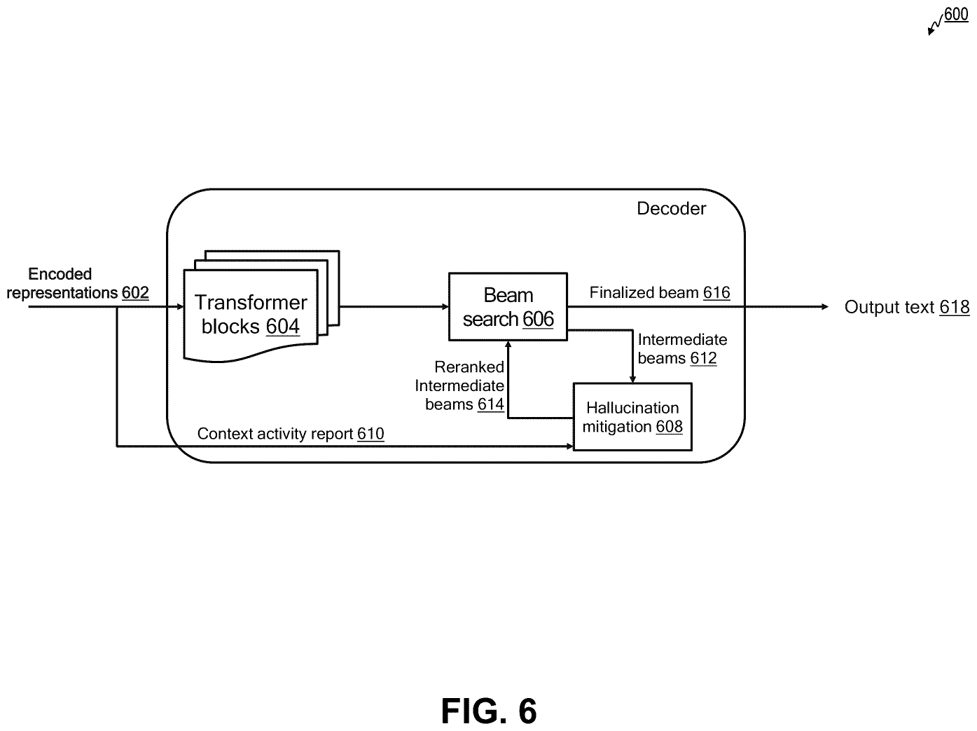

FIG. 6 is a block diagram of a decoder 600 with beam search and a natural language inference (NLI) scorer for a natural language generation (NLG) system. Encoded representations 602 are input into transformer blocks 604 to identify sets of possible tokens. A beam search 606 is used to rank tokens based on probability of use, generating intermediate beams 612 that are input into an NLI scorer 608. The NLI scorer 608, given the intermediate beams 612 and a context activity report 610, in turn generates reranked intermediate beams 614 to input back into the beam search 606 to produce a finalized beam 616 that is ultimately used to generate the output text 618. The NLI scorer 608 is introduced into the beam search 606 decoding process. At every token generation step, the model considers the NLI score from the NLI scorer 608 along with the prediction score from the beam search 606.

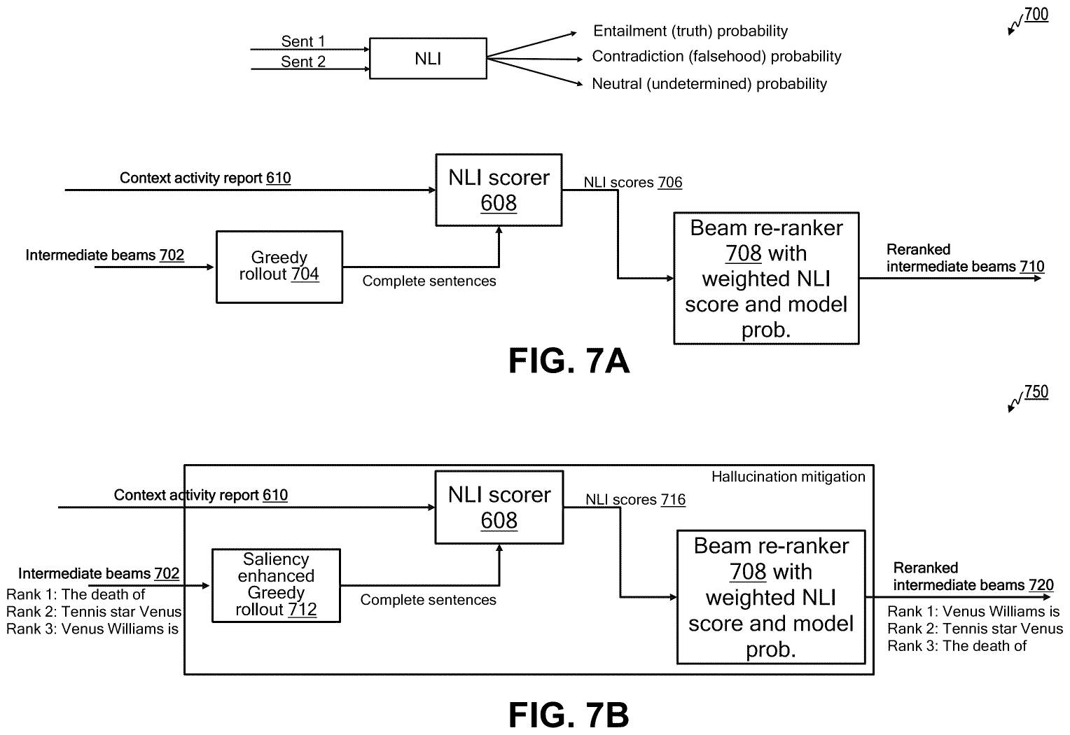

FIG. 7A is a block diagram of a decoder 700 with greedy rollout 704 and a natural language inference (NLI) scorer 608 for a natural language generation (NLG) system. The natural language inference (NLI) can refer to task of determining whether a hypothesis is true (entailment), false (contradiction), or undetermined (neutral, or neither contradiction nor entailment) given a “premise.” In some examples, the respective probabilities of contradiction, entailment, or neutral add up to 1. Thus, if the probability of entailment is high, the probabilities of contradiction and/or neutral can be low. Similarly, if the probability of contradiction is high, the probabilities of entailment and/or neutral can be low. If the probability of neutral is high, the probabilities of contradiction and/or entailment can be low.

FIG. 7B is a block diagram of a decoder 750 with saliency-enhanced greedy rollout 712 and a natural language inference (NLI) scorer 608 for a natural language generation (NLG) system. In some examples, the decoder 700 and/or the decoder 750 can use a Bidirectional Encoder and Autoregressive Decoder Representations from Transformers (BART) Base model finetuned on a given dataset for the NLI-aided beam search re-ranker. Architectures like BART can have an autoregressive decoder that generates the output word by word conditioned on the input text and the words generated so far. A beam search can perform a broad first search with limited branches with the beam size starting with the BOS (Begin of sentence) token and ending the search at EOS (End of sentence) token. Each path from the BOS to the EOS can be referred to as a hypothesis.

$$Equation 2 : Conditional generation$$

$${p}_{θ} ( y \vert x ) = {\prod }_{t = 1}^{\vert y \vert} {p}_{θ} ( {y}_{t} \vert x , {y}_{< y} )$$

An intermediate beam, or partial hypothesis, refers to the sequence of sub paths of hypotheses starting at the BOS and ending before the EOS. Examples of intermediate beams in the context of FIG. 4A include “the nice woman,” “the nice guy,” “the dog has,” and “the dog and,” In the decoder 700, the greedy rollout 704 attends over important parts of the context relevant to intermediate beams 702 (e.g., as in intermediate beams 612) and completes the beam till EOS. In the decoder 750, the saliency enhanced greedy rollout 712 attends over important parts of the context relevant to intermediate beams 702 (e.g., as in intermediate beams 612) and completes the beam till EOS.

The intermediate beams 702 can be selected by the decoder 700 and/or the decoder 750 to include several of the most likely sequences of a specified number of words based on the probability of each word (e.g., using the greedy search decoding algorithm 400 of FIG. 4A and/or the beam search decoding algorithm 450 of FIG. 4B). The decoder 700 and/or the decoder 750 can rank these intermediate beams 702 based on a cumulative probability based on the probability of each word in the respective intermediate beams 702. For instance, FIG. 7B illustrating the decoder 750 indicates that the intermediate beams 702 selected and ranked, with the first rank being “The death of,” the second rank being “Tennis star Venus,” and the third rank being “Venus Williams is.” The

The greedy rollout 704 of the decoder 700 of FIG. 7A uses a greedy search (e.g., as in the greedy search decoding algorithm 400 of FIG. 4A) to add words to each of the intermediate beams 702 until each of the intermediate beams 702 is completed into a respective complete sentence. The saliency enhanced greedy rollout 712 of the decoder 750 of FIG. 7B similarly uses a greedy search (e.g., as in the greedy search decoding algorithm 400 of FIG. 4A) to add words to each of the intermediate beams 702 until each of the intermediate beams 702 is completed into a respective complete sentence, but restricts the view of the greedy rollout model to only the most important or salient words, compared to the greedy rollout 704. For instance, the words determined to be the most important or salient words can be words having a level of saliency or importance exceeding a saliency threshold. In some examples, the saliency threshold can be based on an average saliency value and/or standard deviation saliency value of the respective saliency values of candidate words, so that words with above-average saliency, or with saliency exceeding the average saliency plus a standard deviation (e.g., multiplied by a multiplier), can be considered as exceeding the saliency threshold. Regardless of which type of greedy rollout is used, the NLI scorer 608 then scores each of these complete sentences to generate NLI scores for each of the complete sentences. For instance, the NLI scorer 608 generates the NLI scores 706 for the complete sentences generated by the greedy rollout 704, and generates the NLI scores 716 for the complete sentences generated by the saliency enhanced greedy rollout 712.

The NLI scores for the complete sentences (e.g., NLI scores 706 or NLI scores 716) are sent to the beam re-ranker 708 with weighted NLI score and model probabilities to re-rank the intermediate beams 702 to generate re-ranked intermediate beams. The re-ranked intermediate beams are thus re-ranked based on the complete sentences that each of the intermediate beams are most likely to produce, essentially allowing the decoders to quickly look forward in time at what each of the intermediate beams 702 is likely to turn into using a greedy search, saving time and computational resources compared to doing a more exhaustive search (e.g., a beam search). If the NLI scorer 608 indicates (e.g., via the NLI scores 706 and/or NLI scores 716) that the complete sentence corresponding to a specific intermediate beam (e.g., produced using the greedy rollout 704 or the saliency enhanced greedy rollout 712) includes hallucination(s), factual inaccuracies, contradictions, and/or other errors, then the beam re-ranker 708 can decrease that intermediate beam's ranking down to a lower rank, since this shows that complete sentence(s) generated using that intermediate beam are likely to include hallucination(s), factual inaccuracies, contradictions, and/or other errors. On the other hand, if the NLI scorer 608 indicates (e.g., via the NLI scores 706 and/or NLI scores 716) that the complete sentence corresponding to a specific intermediate beam (e.g., produced using the greedy rollout 704 or the saliency enhanced greedy rollout 712) is free of hallucination(s), factual inaccuracies, contradictions, and/or other errors (or includes fewer of them than the complete sentences corresponding to the other intermediate beams), then the beam re-ranker 708 can increase that intermediate beam's ranking down to a higher rank, since this shows that complete sentence(s) generated using that intermediate beam are likely to be free of hallucination(s), factual inaccuracies, contradictions, and/or other errors. For instance, FIG. 7B illustrating the decoder 750 indicates that the re-ranked intermediate beams 720 that are re-ranked by the beam re-ranker 708 has dropped intermediate beam “The death of” from rank 1 to rank 3 (e.g., based on a high level of hallucination(s) in the corresponding complete sentence as indicated in the NLI scores 716), has increased intermediate beam “Venus Williams is” from rank 3 to rank 1 (e.g., based on the low level (or lack) of hallucination(s) in the corresponding complete sentence as indicated in the NLI scores 716), and has maintained intermediate beam “Tennis star Venus” at rank 2 (e.g., based on a medium level of hallucination(s) in the corresponding complete sentence as indicated in the NLI scores 716).

In some examples, at each beam step, the decoder 750 gradually re-ranks the further beam steps. Each beam step can include a set number of additional words. For instance, the intermediate beams 705 illustrated in FIG. 7B each include 3 words. Once these are re-ranked by the beam re-ranker 708, the system can select the highest-re-ranked beam and continue to generate the text (e.g., the summary) by adding another 3 words, and then using the same hallucination mitigation process (e.g., with the greedy rollout 704 or the saliency enhanced greedy rollout 712, the NLI scorer 608, and the beam re-ranker 708) for a new set of intermediate beams for the next 3 words. For instance, if “Venus Williams is” is chosen, the next set of intermediate beams for the next round of hallucination mitigation can be “Venus Williams is being investigated by,” “Venus Williams is under investigation for,” and “Venus Williams is involved in an.” If, of these, the beam re-ranker 708 ranks “Venus Williams is being investigated by” the highest, then the next set of intermediate beams for the next round of hallucination mitigation can be “Venus Williams is being investigated by police in Florida,” “Venus Williams is being investigated by authorities for an,” “Venus Williams is being investigated by United States police.” Of these, the beam re-ranker 708 can rank “Venus Williams is being investigated by police in Florida” the highest, and can generate the next set of intermediate beams for the next set of three additional words for the next round of hallucination mitigation as discussed above. The process can continue until a complete sentence is generated.

As indicated above, the intermediate beams 702 are sent to the greedy rollout 704 and/or the saliency enhanced greedy rollout 712 to serve as a look-ahead mechanism to complete the beams. Completed candidate beams (e.g., complete sentences 714) are configured to be scored (e.g., NLI scores 706 and/or NLI scores 716) using entailment probability of NLI scorer 608 model. Then the intermediate beams are re-ranked based on the weighted probability between entailment and model probabilities using the beam re-ranker 708 with weighted NLI score and model probabilities. Detailed steps are provided in Pseudocode 1. In some examples, the beam re-ranker 708 with weighted NLI score and model probabilities can re-rank according to the equation below:

Beam re-ranker=log(a*cumulative beam prob+b*NLI entailment prob) Equation 3: Beam Re-Ranker

In some examples, the sum of the parameters a and b in Equation 3 is 1, so if one of these parameters increases, the other parameter decreases. In some examples, increasing the parameter b can increase the level of the hallucination mitigation, and can thus increase faithfulness of the resulting generated text (e.g., the generated summary). In some examples, increasing the parameter a can decrease hallucination mitigation, which can be helpful when the resulting generated text is expected to be neutral or abstract, with little danger of hallucinations. Using the greedy rollout 704 of the decoder 700, greedy search is used to complete the beam (e.g., as in the greedy search decoding algorithm 400 of FIG. 4A).

Regarding greedy rollout 704 and/or saliency enhanced greedy rollout 712—it can be difficult to perform an NLI task on partial hypotheses when the NLI models have been trained with complete sentences. Thus, the decoder 700 and/or the decoder 750 can complete 2B intermediate beams 702 as an initial step (e.g., using the greedy rollout 704 and/or saliency enhanced greedy rollout 712), where B is the beam size. The decoder 700 and/or the decoder 750 can use greedy search (e.g., the greedy rollout 704 and/or saliency enhanced greedy rollout 712) on the intermediate beams 702 to generate the remaining words and complete the partial hypotheses. In Pseudocode 1, the saliency enhanced greedy rollout (SGR) function takes the concatenated input of context, intermediate beam, and next word separated by a sentence separation token ([SEP] token) and generates the completed beams. During greedy search, similar words can be used to complete the beams regardless of the words in intermediate beams. This can be due to long context and shorter attention span of pretrained transformers. Thus, in some examples, the model might not effectively attend to the parts of context relevant to the words in intermediate beam. To solve this problem, the decoder 700 and/or the decoder 750 can take two steps. First, the decoder 700 and/or the decoder 750 can enhance the effectiveness and diversity of greedy search, by introducing saliency on the context relative to intermediate beam using attention head masking (e.g., saliency enhanced greedy rollout 712). The decoder 750 can compute the saliency score for every word or token in context by averaging the cosine distance of it with each word in the intermediate beam. Using a threshold as hyperparameter, the decoder 750 computes mask matrix m (see Equation 4 below) to selectively attend to words in context relevant for the completion of current intermediate beam.

$$Equation 4 : Encoder - Decoder attention with mask m$$

$$Attention ( q , K , V ) = softmax ( \frac{{qK}^{T}}{\sqrt{{d}_{k}}} + m ) V$$

Second, the decoder 700 and/or the decoder 750 can perform the proposed re-ranking only if the hypothesis has a minimum of words, so that the beam doesn't converge to the same space during greedy search. This is because if the hypothesis has very few words, the beam might not have the necessary entities to be suitable for measuring hallucination. In some examples, the decoder 700 and/or the decoder 750 can automatically identify the appropriate time steps that are suitable for re-ranking the hypothesis to avoid hallucination. In some examples, a minimum number of time steps to perform re-ranking is a hyperparameter for the decoders 700 and 750.

Pseudocode 1

```
// Algorithm 1: NLI assisted beam decoding
Input variables: Beam size B, Generative Model M, Vocab V,
wait threshold δ;
Input functions: Saliency enhanced greedy rollout function SGR
returns completed beams,
Natural Language inference function NLI returns entailment
probability;
I = {(Interᵢ, Cumulative Pᵢ) : Interᵢ ∈ set of Intermediate beams};
Context C = {x₁, x₂, x₃, . . xₙ : xᵢ ∈ V};
Candidate Intermediate beams CI = { };
Current Completed beams CC = { };
Completed Generations CG = { };
while |CG| < B do
  for (Interᵢ), Cumulative Pᵢ) in I:
    T:= {(tᵢ, Pᵢ): tᵢ belongs Top 2B tokens of V predicted by Model M
    with Pᵢ probability}
    if Interᵢ > δ:
      for (ti, Pi) in T:
        R: = SGR(M, C, Interᵢ, tᵢ)
        Pₑₙₜₐᵢₗ := NLI(C, R)
        P_{weighted} := αPᵢ + (1 − α)Pₑₙₜₐᵢₗ
        Pᵢ: = P_{weighted}
      end
    end
    CI := {(Interᵢ + tᵢ, Cumulative Pᵢ + Pᵢ): (t, P,) belongs T}
    I := I ∪ Top B beams from CI ranked by Cumulative P
    CC: = {Interᵢ: for all beams Interᵢ belongs I ending with ’ < end > ’
    token}
    I: = I − CC
    CG: = CG ∪ CC
  end
return top-ranked element of CG
```

As a next step, the decoder 700 and/or the decoder 750 can pass the greedy rollout beams to NLI scorer 608. The decoder 700 and/or the decoder 750 obtains the entailment probability with context as premise and beam as hypothesis as illustrated with equation 5. The NLI function takes in Context C as premise and rolled out beam R as hypothesis and computes their relationship as entailment score. In some examples, the entailment probability can be inversely proportional to hallucination content of the beam. To quantify whether the beams are able to explore different regions of text space, the decoder 700 and/or the decoder 750 can use a diversity metric Diversity (see Equation 5 below) to measure the average frequency of novel words across the beams. In some examples, the set intersection operation can incorporate semantic representation(s) of words.

$$Equation 5 : Diversity metric to measure novelty across beams$$

$$Diversity = \frac{{\sum }_{i = 0}^{n - 2} {b}_{i} ⋃ {b}_{i + 1} - {b}_{i} ⋂ {b}_{i + 1}}{{}_{2}^{n} C}$$

In Equation 5 above, n is the beam size and bᵢ is the set of unique words in beam i.

In order to incorporate NLI score into overall cumulative beam probability, the decoder 700 and/or the decoder 750 takes the weighted average of entailment and model probability for each decoding step and adds it to the cumulative beam probability. The beam re-ranker 708 with weighted NI score and model probability then re-ranks the beams based on modified cumulative probability and selects the top B candidates as re-ranked intermediate beams 710. The weights need to be normalized as we are adding two random variables. As mentioned in Equation 6, the decoder 700 and/or the decoder 750 considers the weight (α) as a hyperparameter which can be increased up to 1.0 depending on the necessity of faithfulness in the generated text for a given task.

Pₑₙₜₐᵢₗ:=NLI(C,R)

P_{weighted}:=αPᵢ+(1−α)Pₑₙₜₐᵢₗ Equation 6: Weighted average of entailment and model probabilities

In an illustrative example, the decoder 700 and/or the decoder 750 were tested with two datasets, namely, CNNDM and Xsum, to evaluate model performance. CNNDM corpus is generated from human written multi-line summaries for CNN and Daily Mail news articles. It consists of over 285k training pairs, 13,368 validation pairs and 11,487 test pairs. The Xsum dataset is made up of BBC articles and corresponding one-line summaries. It comprises over 90k training samples and is more abstractive than CNN/DM as it contains 18.6% more novel unigrams. The systems and methods described herein work consistently on both abstractive and extractive types of summaries.

In an illustrative example, the decoder 700 and/or the decoder 750 can use a pytorch implementation of a Bidirectional Encoder and Autoregressive Decoder Representations from Transformers (BART) base version from the huggingface library. In an illustrative example, the decoder 700 and/or the decoder 750 can be trained for 6 epochs using learning rate of 4e⁻⁵ with linear decay. For decoding process, the decoder 700 and/or the decoder 750 can use beam search with beam size 5 and maximum length of 125 tokens after Byte Pair Encoding (BPE) tokenization. In some examples, early stopping is set to true and a repetition penalty is set to 3.0. For NLI, the decoder 700 and/or the decoder 750 can use BART large model finetuned on MNLI dataset.

In an illustrative example, the decoder 700 and/or the decoder 750 can use SummaC model for measuring summary consistency. An NLI model can measure the similarity between each sentence in context and summary by creating a NLI Pair matrix. Two methods, SummaConv and Summac ZS, can be used that differ in the ways of computing the final score. Summac ZS takes a direct maximum of the columns in NLI Pair matrix while the former uses a 1-D convolution to arrive at a single score. In an illustrative example, the decoder 700 and/or the decoder 750 can adopt SummaConv and a diversity score as its evaluation metric. The decoder 700 and the decoder 750 both provide technical improvements over beam search and greedy search alone, such as reduced hallucinations, increased accuracy, and/or increased reliability. In Table 2, the decoder 750 is measured against beam search using the SummaConv score and diversity score. In Table 2, the decoder 750 is benchmarked against 6 consistency datasets including FactCC, SummEval and non-NLI consistency metrics such as DAE and FACTCC.

The beam search modification described herein reduces hallucination during inference time in comparison with beam searches that lack the beam search modification described herein. In Table 2, the increases in SummaConv scores for both Xsum and CNNDM datasets by the decoder 750 relative to beam search alone confirms that NLI helps in reducing hallucination and aligns the generated text with facts from the context. The relative high diversity scores for decoder 750 relative to beam search alone shows that the beams produced by the decoder 750 explore a more diverse range of text to avoid hallucinations (compared to beam search alone).

TABLE 2
Performance of beam search alone against decoder
750 of FIG. 7B on XSum and CNN/DM datasets

| | | Diversity | Summa Conv |
|---|---|---|---|
| Dataset | Decoding algo | score | score |
| XSum | Beam search only | 2.27 | 0.315 |
| | Decoder 750 (α = 0.8) | 2.53 | 0.526 |
| CNN/DM | Beam search only | 1.66 | 0.872 |
| | Decoder 750 (α = 0.6) | 1.69 | 0.898 |

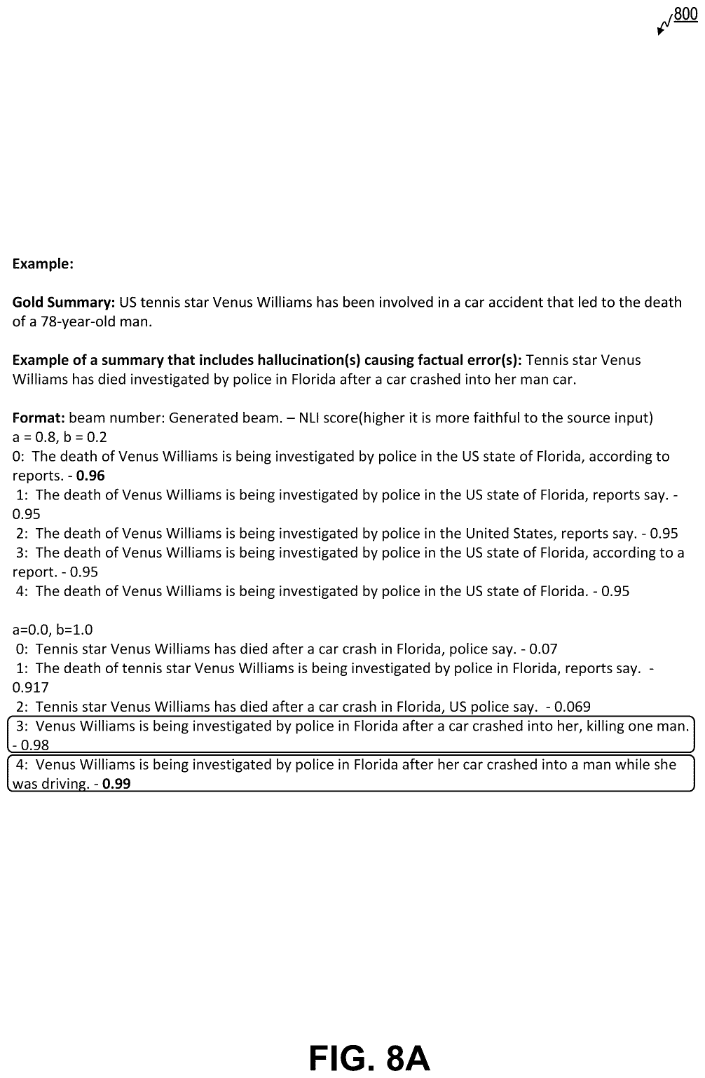

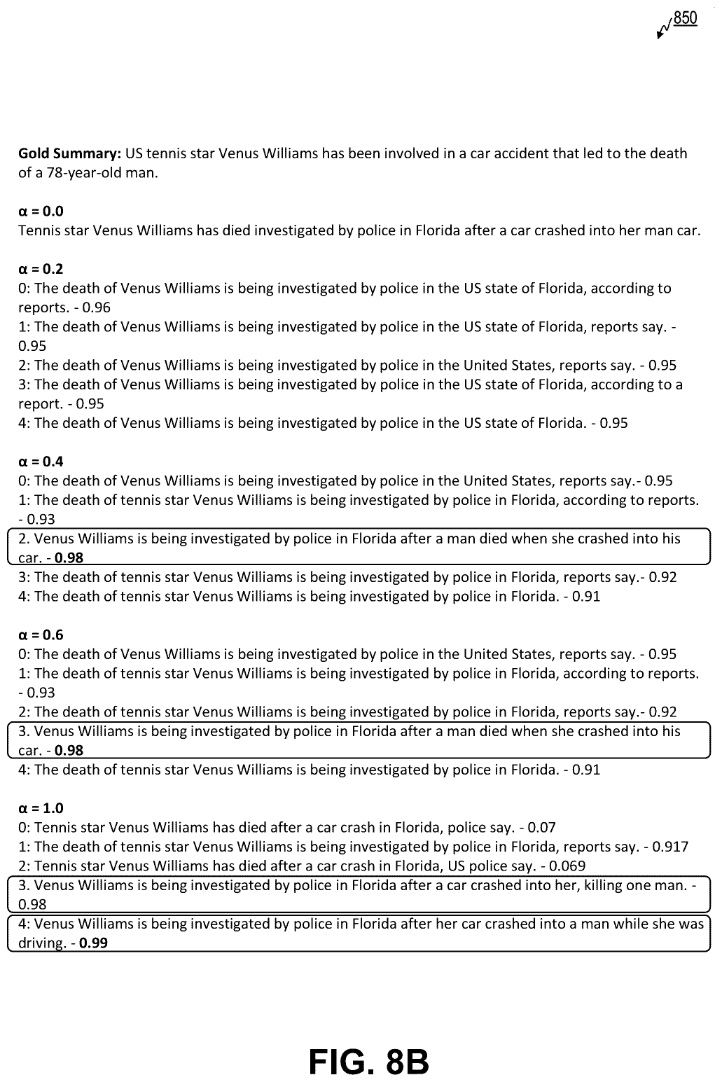

Hyperparameter a plays a role in guiding the beams to factual generation by varying its values across the spectrum. FIG. 8A is a conceptual diagram 800 illustrating examples of different strings of output text with different natural language inference (NLI) scores. In FIG. 8A, different generated summaries are illustrated for different sets of parameters and/or weights. The parameters and/or weights can be inputs to the beam re-ranker 708, and are indicated in FIG. 8A as a and b. The parameters and/or weights as a and b can be the same parameters and/or weights a and b indicated in Equation 3. In some examples, the sum of the parameters a and b is 1, so if one of these parameters increases, the other parameter decreases. In some examples, increasing the parameter b can increase the level of the hallucination mitigation, and can thus increase faithfulness of the resulting generated text (e.g., the generated summary). In some examples, increasing the parameter a can decrease hallucination mitigation, which can be helpful when the resulting generated text is expected to be neutral or abstract, with little danger of hallucinations.

Table 3 below illustrates the effects of Entailment (E) and Contradiction (C) NLI probabilities on overall performance of the decoder 700 and/or the decoder 750.

TABLE 3
Effect of Entailment (E) and Contradiction (C)
NLI probabilities on overall performance

| | XSum | | CNN/DM | |
|---|---|---|---|---|
| Model vs. | Diversity | SummaConv | Diversity | SummaConv |
| Dataset | Score | Score | Score | Score |
| Beam Search | 2.27 | 0.315 | 1.66 | 0.872 |
| Only | | | | |
| Decoder 750 (E) | 2.53 | 0.526 | 1.69 | 0.898 |
| Decoder 750 | 2.54 | 0.442 | 1.94 | 0.710 |
| (E & C) | | | | |

Table 3 illustrates examples of combining the contradiction probability with the entailment probability as illustrated using Equation 7. For the examples in Table 3, α₁=0.6 and α₂=0.2.

p_{prob}:=α₁·pₑₙₜₐᵢₗ+(1−α₁)·P_{contradiction}

p_{weighted}:=α₂·Pᵢ+(1−α₂)·P_{prob} Equation 7: Weighted average of entailment and model probabilities

Table 4 below illustrates an analysis of different decoding strategies for the rollout component (e.g., greedy rollout 705 and/or saliency enhanced greedy rollout 712) of the decoder 700 and/or the decoder 750. An increase of 0.212 is visible in Table 4 for random sampling rollout compared to greedy rollout. Since XSum is generally abstractive, random sampling helps in exploring less frequent faithful words which would have been overlooked by other methods. Since CNN/DM is mostly extractive, greedy search is able to select the highest probable word which mostly occurs in context

TABLE 4
Analysis of different decoding strategies for rollout component

| Rollout | XSum | | CNN/DM | |
|---|---|---|---|---|
| decoding vs. | Diversity | SummaConv | Diversity | SummaConv |
| Dataset | Score | Score | Score | Score |
| Random | 2.55 | 0.738 | 1.82 | 0.301 |
| Sampling | | | | |
| Top P (P = 0.92) | 2.63 | 0.363 | 1.65 | 0.234 |
| Top K (K = 50) | 2.57 | 0.570 | 1.89 | 0.785 |
| Greedy | 2.54 | 0.526 | 1.69 | 0.898 |

Table 5 below illustrates the effects of different NLI datasets, such as Multi-Genre Natural Language Inference (MNLI) and Stanford Natural Language Inference (SNLI), on overall SummaConv score for the decoder 700 and/or the decoder 750:

TABLE 5
Effect of NLI datasets on overall SummaConv score

| | XSum | | CNN/DM | |
|---|---|---|---|---|
| NLI dataset | Diversity | SummaConv | Diversity | SummaConv |
| vs. Dataset | Score | Score | Score | Score |
| MNLI | 2.54 | 0.526 | 1.69 | 0.898 |
| SNLI | 2.78 | 0.643 | 1.76 | 0.929 |

In FIG. 8A, a gold summary is illustrated. The gold summary is a human-generated summary of a news article, and reads “US tennis star Venus Williams has been involved in a car accident that led to the death of a 78-year-old man.” An exemplary bad summary generated by a bad model is illustrated as “Tennis star Venus Williams has died investigated by police in Florida after a car crashed into her man car,” which is factually inaccurate and inconsistent with the article and the corresponding gold summary.

In FIG. 8A, ten summaries of the article are illustrated generated using the systems and methods described herein (e.g., using the decoder 750). Of these ten summaries, a first set of five summaries are written with the parameters set to a=0.8 and b=0.2. This first set of five summaries all have factual inaccuracies, for instance suggesting that Venus Williams died. Of the ten summaries, a second set of five summaries are written with the parameters set to a=0.0 and b=1.0. This second set of five summaries include three summaries that include factual inaccuracies (again suggesting that Venus Williams died) and two summaries that are factually accurate (labeled #3 and #4 and outlined in black rounded rectangles). Each of the ten summaries is followed by a respective confidence value generated by the decoder 750 (e.g., by the beam re-ranker 708) indicating a confidence that the summary is accurate. The two summaries that are factually accurate have the highest confidence values of the ten summaries, at 0.98 and 0.99, respectively.

FIG. 8B is a conceptual diagram 850 illustrating examples of different strings of output text with different natural language inference (NLI) scores. In FIG. 8B, for parameter α=0.0 and α=0.2, all the generated beams illustrated in FIG. 8B are factually incorrect. In FIG. 8B, from α=0.4 to 1.0 the frequency of factually consistent generated beams steadily increases, indicating that greater the influence of NLI, higher the factual consistency of the generated beams. Parameter α can be an input into the beam re-ranker 708, for instance as in Equation 7. Each of the summaries is followed by a respective confidence value generated by the decoder 750 (e.g., by the beam re-ranker 708) indicating a confidence that the summary is accurate. The four summaries that are factually accurate are outlined with rounded rectangles and have the highest confidence values of the summaries in FIG. 8B, with each having a confidence value of either 0.98 and 0.99.

In some examples, use of entailment probability and contradiction probability can have different effects of NLI scorer. In some examples, the decoder 700 and/or the decoder 750 can take a weighted average of entailment and contradiction probabilities and combine the weighted average with token probability. P_{weighted} in Pseudocode 1 can be modified using Equation 7 below:

P_{prob}:=α₁Pₑₙₜₐᵢₗ+(1−α₁)P_{contradiction}

P_{weighted}:=α₂Pᵢ+(1−α)P_{prob} Equation 7: Combination of entailment and contradiction probability

In some examples, the decoder 700 and/or the decoder 750 can be affected by a correlation of saliency attentions between intermediate beam and context. In some examples, each word in the intermediate beam can influence the saliency to a greater extent to establish the importance of cross attention between the two components.

With the analysis on correlation of entailment scores with entity hallucinations, NLI models can be used as a reliable guide to mitigate hallucinations during inference time. The decoder 600, the decoder 700, and/or the decoder 750 show modifications to beam search decoding algorithms that guide beam generation to avoid falling into hallucination regions by re-ranking the beams based on NLI entailment scores computed on saliency enhanced greedily rolled out partial hypotheses. In some examples, the NLI-based re-ranker can consistently improve a SummaConv score. In some examples, the NLI-based re-ranker can further improve other NLP downstream tasks, such as story generation with a prompt, question answering, and query-focused summarization. In some examples, NLI can be incorporated as a guidance mechanism for decoding algorithms. In some examples, NLI can be expanded to other NLG tasks, like question answering.

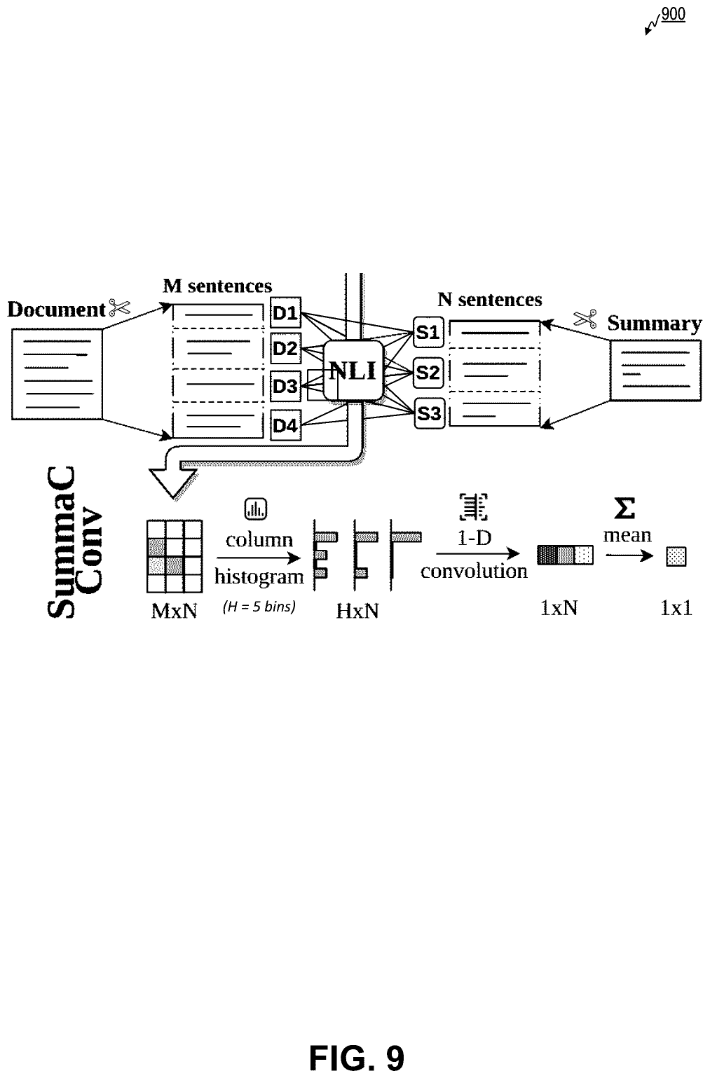

FIG. 9 is a conceptual diagram illustrating a model 900 for generating a summary of input content using a natural language generation (NLG) system. In some examples, the system can generate output text that is truthful to the source input text. In word-by-word text generation process, the system can aid in keeping the model in right track. If available, the system can provide a summary of objective measures of performance. For instance, Summac Conv can compute a factuality score by segmenting input and output text into sentence units and aggregating natural language inference (NLI) scores between pairs of sentences. Rouge (R-1, R-2, R-L) can compare the overlap of words/phrases between generated summaries and gold summaries (e.g., pre-determined summaries written by a human). A diversity score can be used to compute how different the generated beams are by comparing their word overlaps. In some examples, the model 900 can be used to check factuality of the summary as a quality check after a summary is generated. In some examples, the model 900 can be part of the NLI scorer 608.

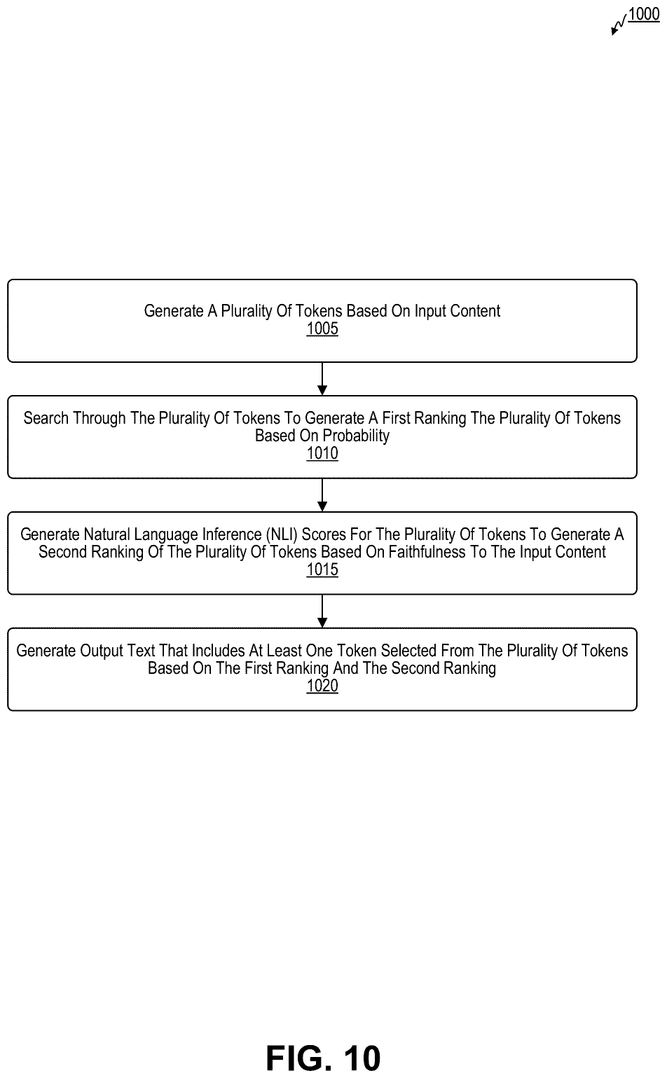

FIG. 10 is a flowchart illustrating an example process 1000 for language generation (NLG) using one or more of the techniques described herein. The process 1000 can be performed using a NLG system, which may include, for instance, the NLG system 300, the NLG system 350, the encoder 304, the decoder 306, the decoder with hallucination mitigation 310, the decoder 600, the transformer blocks 604, the beam search 606, the NLI scorer 608, the decoder 700, the decoder 750, the greedy rollout 704, the beam re-ranker 708 with weighted NLI score and model probabilities, the saliency-enhanced greedy rollout 712, the model 900, the NN 1100, the computing system 1200, or a combination thereof.

At operation 1005, the NLG system (or at least one subsystem thereof) is configured to, and can, generate a sequence of tokens based on input content. In some examples, the input content includes input text (e.g., input text 302), input speech, or a combination thereof. The sequence of tokens can correspond to the intermediate beams 702.

At operation 1010, the NLG system (or at least one subsystem thereof) is configured to, and can, determine a confidence level associated with the sequence of tokens based on respective confidence levels associated with each token in the sequence of tokens. The confidence level can correspond to the initial ranking of the intermediate beams 702 before hallucination mitigation as illustrated in FIG. 7B.

At operation 1015, the NLG system (or at least one subsystem thereof) is configured to, and can, generate a complete sentence that includes the sequence of tokens, for instance using the greedy rollout 704 or the saliency-enhanced greedy rollout 712.

In some aspects, the NLG system (or at least one subsystem thereof) is configured to, and can, generate the sequence of tokens using a beam search based on the input content (e.g., as in the beam search of FIG. 4B and/or the beam search 606), using a greedy search based on the input content (e.g., as in the greedy search of FIG. 4A, the greedy rollout 704, and/or the saliency enhanced greedy rollout 712), or a combination thereof. In some aspects, the NLG system (or at least one subsystem thereof) is configured to, and can, generating the complete sentence using a greedy search based on the sequence of tokens (e.g., as in the greedy search of FIG. 4A, the greedy rollout 704, and/or the saliency enhanced greedy rollout 712), using a beam search based on the sequence of tokens (e.g., as in the beam search of FIG. 4B and/or the beam search 606), or a combination thereof.

In some aspects, the NLG system (or at least one subsystem thereof) is configured to, and can, restrict candidate tokens for use in generating the complete sentence based on whether respective saliency values for the candidate tokens exceed a saliency threshold. In some aspects, the saliency threshold is based on an average of the respective saliency values for the candidate tokens. For instance, the threshold can be the average (e.g., mean, median, mode) of the respective saliency values, the average of the respective saliency values offset by an offset value (e.g., a product of a standard deviation an a multiplier), a product of the average of the respective saliency values offset and a multiplier, or a combination thereof.

In some aspects, the sequence of tokens is configured to follow after a previously-determined sequence of tokens in the complete sentence, and the complete sentence includes the previously-determined sequence of tokens, the sequence of tokens, and at least one additional token.

At operation 1020, the NLG system (or at least one subsystem thereof) is configured to, and can, generate a natural language inference (NLI) score (e.g., one of the NLI scores 706 or one of the NLI scores 716) for the complete sentence based on faithfulness of the complete sentence to the input content (e.g., based on the context activity report 610).

In some aspects, an NLI score of the NLI scores identifies whether at least a portion of the complete sentence (e.g., a token or a resulting statement in the output text) is true, false, or neutral (e.g., as illustrated in FIG. 7A) (e.g., relative to the input content).

At operation 1025, the NLG system (or at least one subsystem thereof) is configured to, and can, adjust the confidence level for the sequence of tokens based on the NLI score for the complete sentence to generate an updated confidence level for the sequence of tokens. The updated confidence level can correspond to the re-ranking of the intermediate beams 702, and/or the ranking of the re-ranked intermediate beams (e.g., re-ranked intermediate beams 710 or the re-ranked intermediate beams 720), by the beam re-ranker 708 following hallucination mitigation as illustrated in FIGS. 7A-7B

For instance, in some aspects, the NLG system (or at least one subsystem thereof) is configured to, and can, rank the sequence of tokens against a second sequence of tokens based on the confidence level associated with the sequence of tokens and a second confidence level associated with the second sequence of tokens. In some aspects, the NLG system (or at least one subsystem thereof) is configured to, and can, re-rank the sequence of tokens against the second sequence of tokens based on the updated confidence level associated with the sequence of tokens and a second updated confidence level associated with the second sequence of tokens. The second updated confidence level is based on a second NLI score for a second complete sentence generated based on the second sequence of tokens. In some aspects, the NLG system (or at least one subsystem thereof) is configured to, and can, select a highest-ranked sequence of tokens from at least the sequence of tokens and the second sequence of tokens based on the re-ranking of the sequence of tokens against the second sequence of tokens. The NLG system (or at least one subsystem thereof) can generate output text including the highest-ranked sequence of tokens. In some aspects, the output text is configured to summarize the input content.

In some aspects, the NLG system (or at least one subsystem thereof) is configured to, and can, generate output text including the sequence of tokens based on the updated confidence level for the sequence of tokens exceeding a second updated confidence level for a second sequence of tokens. In some aspects, the NLG system (or at least one subsystem thereof) is configured to, and can, generate the second sequence of tokens based on the input content. The NLG system (or at least one subsystem thereof) can determine a second confidence level associated with the second sequence of tokens based on secondary respective confidence levels associated with each token in the second sequence of tokens. The NLG system (or at least one subsystem thereof) can generate a second complete sentence that includes the second sequence of tokens. The NLG system (or at least one subsystem thereof) can generate a second NLI score for the second complete sentence based on faithfulness of the second complete sentence to the input content. The NLG system (or at least one subsystem thereof) can adjust the second confidence level for the second sequence of tokens based on the second NLI score for the second complete sentence to generate the second updated confidence level for the second sequence of tokens. In some aspects, the output text is configured to summarize the input content.

In some aspects, the output text is configured to summarize the input content (e.g., as in the news article summarizer of FIGS. 8A-8B).

In some aspects, the input content includes input text. In some aspects, the at least one token is at least a portion of a word (e.g., such as any of the words in FIG. 4A, FIG. 4B, FIG. 8A, or FIG. 8B). In some aspects, each token of the sequence of tokens is at least a portion of a respective word.

In some aspects, the plurality of tokens are also based on at least one previously-generated output token of the output text. For instance, in FIG. 4A, “nice” would be a previously-generated output token to “woman,” and “woman” can be generated or selected based on the previously-generated output token “nice.” Similarly, in FIG. 4A, “The” would be a previously-generated output token to “nice,” and “nice” can be generated or selected based on the previously-generated output token “The.”

In some aspects, searching through the plurality of tokens to generate the first ranking includes using a beam search (e.g., as in FIG. 4B and FIG. 6). In some aspects, searching through the plurality of tokens to generate the first ranking includes using a greedy search (e.g., as in FIG. 4A, FIG. 7A, and FIG. 7B).

In some aspects, the NLG system (or at least one subsystem thereof) is configured to, and can, output the output text. In some aspects, the NLG system (or at least one subsystem thereof) is configured to, and can, cause a display to display the output text. In some aspects, the NLG system (or at least one subsystem thereof) is configured to, and can, cause a communication interface to transmit the output text to a recipient device.

In some examples, the NLG system includes: means for generating a plurality of tokens based on input content; means for searching through the plurality of tokens to generate a first ranking the plurality of tokens based on probability; means for generating natural language inference (NLI) scores for the plurality of tokens to generate a second ranking of the plurality of tokens based on faithfulness to the input content; and means for generating output text that includes at least one token selected from the plurality of tokens based on the first ranking and the second ranking. The means for performing these operations can include, for instance, the NLG system 300, the NLG system 350, the encoder 304, the decoder 306, the decoder with hallucination mitigation 310, the decoder 600, the transformer blocks 604, the beam search 606, the NLI scorer 608, the decoder 700, the decoder 750, the greedy rollout 704, the beam re-ranker 708 with weighted NLI score and model probabilities, the saliency-enhanced greedy rollout 712, the model 900, the NN 1100, the computing system 1200, or a combination thereof.

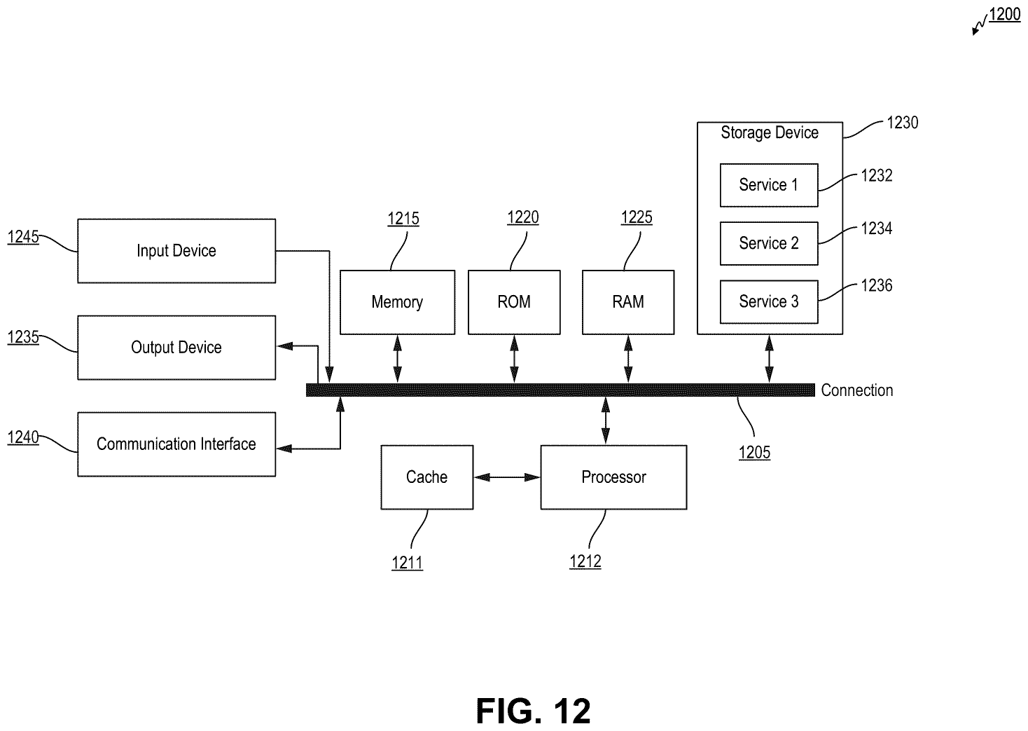

In some examples, the processes described herein (e.g., process 1000 and/or any other process described herein) may be performed by a computing device or apparatus. In one example, the process 1000 can be performed by the NLG system 300, the NLG system 350, the encoder 304, the decoder 306, the decoder with hallucination mitigation 310, the decoder 600, the transformer blocks 604, the beam search 606, the NLI scorer 608, the decoder 700, the decoder 750, the greedy rollout 704, the beam re-ranker 708 with weighted NLI score and model probabilities, the saliency-enhanced greedy rollout 712, the model 900, the NN 1100, the computing system 1200, or a combination thereof. For instance, a computing device with the computing device architecture of the computing system 1200 shown in FIG. 12 can implement the operations of FIG. 10 and/or the components and/or operations described herein with respect to any of FIGS. 3A, 3B, 6, 7A, 7B, 9, 11, and/or 12.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the process 1000 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1000 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the 1000 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

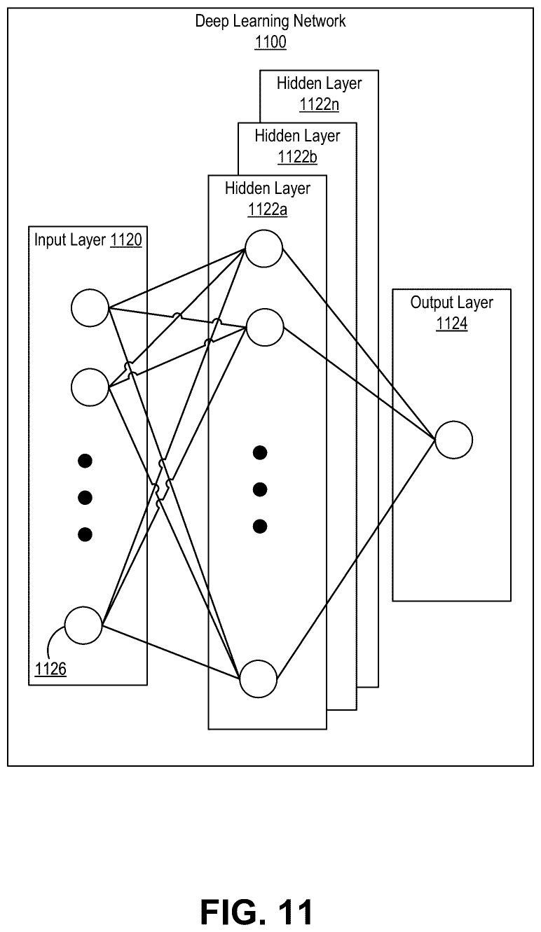

As described herein, the neural network system 1100 of FIG. 11 may be implemented using a neural network or multiple neural networks. FIG. 11 is an illustrative example of a deep learning neural network 1100 that can be used by the neural network system 1100 of FIG. 11. An input layer 1120 includes input data. In one illustrative example, the input layer 1120 can include data representing the pixels of an input video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1124 that provides an output resulting from the processing performed by the hidden layers 1122a, 1122b, through 1122n. In one illustrative example, the output layer 1124 can provide a classification for an object in an input video frame. The classification can include a class identifying the type of object (e.g., a person, a dog, a cat, or other object).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the hidden layers 1122a, 1122b, through 1122n can transform the information of each input node by applying activation functions to the information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1124, at which an output is provided. In some cases, while nodes (e.g., node 1126) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1122n in order to provide the output through the output layer 1124. In an example in which the neural network 1100 is used to identify objects in images, the neural network 1100 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1100 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1100 is trained well enough so that the weights of the layers are accurately tuned.

For the example of identifying objects in images, the forward pass can include passing a training image through the neural network 1100. The weights are initially randomized before the neural network 1100 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as Eₜₒₜₐₗ=Σ½ (target−output)², which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1100 can perform a backward pass by determining which inputs (weights) most contributed to the loss of the network, and can adjust the weights so that the loss decreases and is eventually minimized.

A derivative of the loss with respect to the weights (denoted as dL/dW, where Ware the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

In some cases, the neural network 1100 can be trained using self-supervised learning.

The neural network 1100 can include any suitable deep network. One example includes a convolutional neural network (CNN), which includes an input layer and an output layer, with multiple hidden layers between the input and out layers. An example of a CNN is described below with respect to FIG. 12. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

FIG. 12 is a diagram illustrating an example of a system for implementing certain aspects of the present disclosure. In particular, FIG. 12 illustrates an example of computing system 1200, which can be for example any computing device making up a computing system, a camera system, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some examples, computing system 1200 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some examples, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for natural language processing, the apparatus comprising: at least one memory; and at least one processor coupled to the at least one memory, the at least one processor being configured to: generate a sequence of tokens based on input content; determine a confidence level associated with the sequence of tokens based on respective confidence levels associated with each token in the sequence of tokens; generate a complete sentence that includes the sequence of tokens; generate a natural language inference (NLI) score for the complete sentence based on faithfulness of the complete sentence to the input content; and adjust the confidence level for the sequence of tokens based on the NLI score for the complete sentence to generate an updated confidence level for the sequence of tokens.

Aspect 2. The apparatus of Aspect 1, the at least one processor configured to: generate the sequence of tokens using a beam search based on the input content.

Aspect 3. The apparatus of any of Aspects 1 to 2, the at least one processor configured to: generate the complete sentence using a greedy search based on the sequence of tokens.

Aspect 4. The apparatus of any of Aspects 1 to 3, the at least one processor configured to: restrict candidate tokens for use in generating the complete sentence based on whether respective saliency values for the candidate tokens exceed a saliency threshold.

Aspect 5. The apparatus of Aspect 4, wherein the saliency threshold is based on an average of the respective saliency values for the candidate tokens.

Aspect 6. The apparatus of any of Aspects 1 to 5, the at least one processor configured to: rank the sequence of tokens against a second sequence of tokens based on the confidence level associated with the sequence of tokens and a second confidence level associated with the second sequence of tokens.

Aspect 7. The apparatus of Aspect 6, the at least one processor configured to: re-rank the sequence of tokens against the second sequence of tokens based on the updated confidence level associated with the sequence of tokens and a second updated confidence level associated with the second sequence of tokens, wherein the second updated confidence level is based on a second NLI score for a second complete sentence generated based on the second sequence of tokens.

Aspect 8. The apparatus of Aspect 7, the at least one processor configured to: select a highest-ranked sequence of tokens from at least the sequence of tokens and the second sequence of tokens based on the re-ranking of the sequence of tokens against the second sequence of tokens; and generate output text including the highest-ranked sequence of tokens.

Aspect 9. The apparatus of Aspect 8, wherein the output text is configured to summarize the input content.

Aspect 10. The apparatus of any of Aspects 1 to 9, the at least one processor configured to: generate output text including the sequence of tokens based on the updated confidence level for the sequence of tokens exceeding a second updated confidence level for a second sequence of tokens.

Aspect 11. The apparatus of Aspect 10, the at least one processor configured to: generate the second sequence of tokens based on the input content; determine a second confidence level associated with the second sequence of tokens based on secondary respective confidence levels associated with each token in the second sequence of tokens; generate a second complete sentence that includes the second sequence of tokens; generate a second NLI score for the second complete sentence based on faithfulness of the second complete sentence to the input content; and adjust the second confidence level for the second sequence of tokens based on the second NLI score for the second complete sentence to generate the second updated confidence level for the second sequence of tokens.

Aspect 12. The apparatus of any of Aspects 10 to 11, wherein the output text is configured to summarize the input content.

Aspect 13. The apparatus of any of Aspects 1 to 12, wherein the NLI score identifies whether at least a portion of the complete sentence is true, false, or neutral.

Aspect 14. The apparatus of any of Aspects 1 to 13, wherein the input content includes input text.

Aspect 15. The apparatus of any of Aspects 1 to 14, wherein each token of the sequence of tokens is at least a portion of a respective word.

Aspect 16. The apparatus of any of Aspects 1 to 15, wherein the sequence of tokens is configured to follow after a previously-determined sequence of tokens in the complete sentence, wherein the complete sentence includes the previously-determined sequence of tokens, the sequence of tokens, and at least one additional token.

Aspect 17. The apparatus of any of Aspects 1 to 16, the at least one processor configured to: generate the sequence of tokens using a greedy search based on the input content.

Aspect 18. The apparatus of any of Aspects 1 to 17, wherein the at least one processor is configured to: output output text that includes the sequence of tokens.

Aspect 19. The apparatus of any of Aspects 1 to 18, wherein the at least one processor is configured to: cause a display to display output text that includes the sequence of tokens.

Aspect 20. The apparatus of any of Aspects 1 to 19, further comprising: a communication interface configured to transmit output text that includes the sequence of tokens to a recipient device.

Aspect 21. The apparatus of any of Aspects 1 to 20, wherein the apparatus includes at least one of a head-mounted display (HMD), a mobile handset, or a wireless communication device.

Aspect 22. A method for natural language processing, the method comprising: generating a sequence of tokens based on input content; determining a confidence level associated with the sequence of tokens based on respective confidence levels associated with each token in the sequence of tokens; generating a complete sentence that includes the sequence of tokens; generating a natural language inference (NLI) score for the complete sentence based on faithfulness of the complete sentence to the input content; and adjusting the confidence level for the sequence of tokens based on the NLI score for the complete sentence to generate an updated confidence level for the sequence of tokens.

Aspect 23. The method of Aspect 22, further comprising: generating the sequence of tokens using a beam search based on the input content.

Aspect 24. The method of any of Aspects 22 to 23, further comprising: generating the complete sentence using a greedy search based on the sequence of tokens.

Aspect 25. The method of any of Aspects 22 to 24, further comprising: restricting candidate tokens for use in generating the complete sentence based on whether respective saliency values for the candidate tokens exceed a saliency threshold.

Aspect 26. The method of Aspect 25, wherein the saliency threshold is based on an average of the respective saliency values for the candidate tokens.

Aspect 27. The method of any of Aspects 22 to 26, further comprising: ranking the sequence of tokens against a second sequence of tokens based on the confidence level associated with the sequence of tokens and a second confidence level associated with the second sequence of tokens.

Aspect 28. The method of Aspect 27, further comprising: re-ranking the sequence of tokens against the second sequence of tokens based on the updated confidence level associated with the sequence of tokens and a second updated confidence level associated with the second sequence of tokens, wherein the second updated confidence level is based on a second NLI score for a second complete sentence generated based on the second sequence of tokens.

Aspect 29. The method of Aspect 28, further comprising: selecting a highest-ranked sequence of tokens from at least the sequence of tokens and the second sequence of tokens based on the re-ranking of the sequence of tokens against the second sequence of tokens; and generating output text including the highest-ranked sequence of tokens.

Aspect 30. The method of Aspect 29, wherein the output text is configured to summarize the input content.

Aspect 31. The method of any of Aspects 22 to 30, further comprising: generating output text including the sequence of tokens based on the updated confidence level for the sequence of tokens exceeding a second updated confidence level for a second sequence of tokens.

Aspect 32. The method of Aspect 31, further comprising: generating the second sequence of tokens based on the input content; determining a second confidence level associated with the second sequence of tokens based on secondary respective confidence levels associated with each token in the second sequence of tokens; generating a second complete sentence that includes the second sequence of tokens; generating a second NLI score for the second complete sentence based on faithfulness of the second complete sentence to the input content; and adjusting the second confidence level for the second sequence of tokens based on the second NLI score for the second complete sentence to generate the second updated confidence level for the second sequence of tokens.

Aspect 33. The method of any of Aspects 31 to 32, wherein the output text is configured to summarize the input content.

Aspect 34. The method of any of Aspects 22 to 33, wherein the NLI score identifies whether at least a portion of the complete sentence is true, false, or neutral.

Aspect 35. The method of any of Aspects 22 to 34, wherein the input content includes input text.

Aspect 36. The method of any of Aspects 22 to 35, wherein each token of the sequence of tokens is at least a portion of a respective word.

Aspect 37. The method of any of Aspects 22 to 36, wherein the sequence of tokens is configured to follow after a previously-determined sequence of tokens in the complete sentence, wherein the complete sentence includes the previously-determined sequence of tokens, the sequence of tokens, and at least one additional token.

Aspect 38. The method of any of Aspects 22 to 37, further comprising: generating the sequence of tokens using a greedy search based on the input content.

Aspect 39. The method of any of Aspects 22 to 38, further comprising: outputting output text that includes the sequence of tokens.

Aspect 40. The method of any of Aspects 22 to 39, further comprising: causing a display to display output text that includes the sequence of tokens.

Aspect 41. The method of any of Aspects 22 to 40, further comprising: causing a communication interface to transmit output text that includes the sequence of tokens to a recipient device.

Aspect 42. The method of any of Aspects 22 to 41, wherein the method is performed using an apparatus that includes at least one of a head-mounted display (HMD), a mobile handset, or a wireless communication device.

Aspect 43. A non-transitory computer-readable medium having stored thereon instructions which, when executed by at least one processor, cause the at least one processor to perform operations according to any of Aspects 1 to 42.

Aspect 44. An apparatus comprising means for performing operations according to any of Aspects 1 to 42.

What is claimed is:

1. An apparatus for natural language processing, the apparatus comprising:
at least one memory; and
at least one processor coupled to the at least one memory, the at least one processor configured to:
generate a sequence of tokens based on input content;
determine a confidence level associated with the sequence of tokens based on respective confidence levels associated with each token in the sequence of tokens;
generate a complete sentence that includes the sequence of tokens;
generate a natural language inference (NLI) score for the complete sentence based on faithfulness of the complete sentence to the input content; and
adjust the confidence level for the sequence of tokens based on the NLI score for the complete sentence to generate an updated confidence level for the sequence of tokens.

2. The apparatus of claim 1, the at least one processor configured to:
generate the sequence of tokens using a beam search based on the input content.

3. The apparatus of claim 1, the at least one processor configured to:
generate the complete sentence using a greedy search based on the sequence of tokens.

4. The apparatus of claim 1, the at least one processor configured to:
restrict candidate tokens for use in generating the complete sentence based on whether respective saliency values for the candidate tokens exceed a saliency threshold.

5. The apparatus of claim 4, wherein the saliency threshold is based on an average of the respective saliency values for the candidate tokens.

6. The apparatus of claim 1, the at least one processor configured to:
rank the sequence of tokens against a second sequence of tokens based on the confidence level associated with the sequence of tokens and a second confidence level associated with the second sequence of tokens.

7. The apparatus of claim 6, the at least one processor configured to:
re-rank the sequence of tokens against the second sequence of tokens based on the updated confidence level associated with the sequence of tokens and a second updated confidence level associated with the second sequence of tokens, wherein the second updated confidence level is based on a second NLI score for a second complete sentence generated based on the second sequence of tokens.

8. The apparatus of claim 7, the at least one processor configured to:
select a highest-ranked sequence of tokens from at least the sequence of tokens and the second sequence of tokens based on the re-ranking of the sequence of tokens against the second sequence of tokens; and
generate output text including the highest-ranked sequence of tokens.

9. The apparatus of claim 8, wherein the output text is configured to summarize the input content.

10. The apparatus of claim 1, the at least one processor configured to:
generate output text including the sequence of tokens based on the updated confidence level for the sequence of tokens exceeding a second updated confidence level for a second sequence of tokens.

11. The apparatus of claim 10, the at least one processor configured to:
generate the second sequence of tokens based on the input content;
determine a second confidence level associated with the second sequence of tokens based on secondary respective confidence levels associated with each token in the second sequence of tokens;
generate a second complete sentence that includes the second sequence of tokens;
generate a second NLI score for the second complete sentence based on faithfulness of the second complete sentence to the input content; and
adjust the second confidence level for the second sequence of tokens based on the second NLI score for the second complete sentence to generate the second updated confidence level for the second sequence of tokens.

12. The apparatus of claim 10, wherein the output text is configured to summarize the input content.

13. The apparatus of claim 1, wherein the NLI score identifies whether at least a portion of the complete sentence is true, false, or neutral.

14. The apparatus of claim 1, wherein the input content includes input text.

15. The apparatus of claim 1, wherein each token of the sequence of tokens is at least a portion of a respective word.

16. The apparatus of claim 1, wherein the sequence of tokens is configured to follow after a previously-determined sequence of tokens in the complete sentence, wherein the complete sentence includes the previously-determined sequence of tokens, the sequence of tokens, and at least one additional token.

17. The apparatus of claim 1, the at least one processor configured to:
generate the sequence of tokens using a greedy search based on the input content.

18. The apparatus of claim 1, wherein the at least one processor is configured to:
output output text that includes the sequence of tokens.

19. The apparatus of claim 1, wherein the at least one processor is configured to:
cause a display to display output text that includes the sequence of tokens.

20. The apparatus of claim 1, further comprising:
a communication interface configured to transmit output text that includes the sequence of tokens to a recipient device.

21. The apparatus of claim 1, wherein the apparatus includes at least one of a head-mounted display (HMD), a mobile handset, or a wireless communication device.

22. A method for natural language processing, the method comprising:
generating a sequence of tokens based on input content;
determining a confidence level associated with the sequence of tokens based on respective confidence levels associated with each token in the sequence of tokens;
generating a complete sentence that includes the sequence of tokens;
generating a natural language inference (NLI) score for the complete sentence based on faithfulness of the complete sentence to the input content; and
adjusting the confidence level for the sequence of tokens based on the NLI score for the complete sentence to generate an updated confidence level for the sequence of tokens.

23. The method of claim 22, further comprising:
generating the sequence of tokens using a beam search based on the input content.

24. The method of claim 22, further comprising:
generating the complete sentence using a greedy search based on the sequence of tokens.

25. The method of claim 22, further comprising:
restricting candidate tokens for use in generating the complete sentence based on whether respective saliency values for the candidate tokens exceed a saliency threshold.

26. The method of claim 22, further comprising:
ranking the sequence of tokens against a second sequence of tokens based on the confidence level associated with the sequence of tokens and a second confidence level associated with the second sequence of tokens.

27. The method of claim 26, further comprising:
re-ranking the sequence of tokens against the second sequence of tokens based on the updated confidence level associated with the sequence of tokens and a second updated confidence level associated with the second sequence of tokens, wherein the second updated confidence level is based on a second NLI score for a second complete sentence generated based on the second sequence of tokens.

28. The method of claim 22, further comprising:
generating output text including the sequence of tokens based on the updated confidence level for the sequence of tokens exceeding a second updated confidence level for a second sequence of tokens.

29. The method of claim 22, further comprising:
generating the sequence of tokens using a greedy search based on the input content.

30. The method of claim 22, further comprising:
outputting output text that includes the sequence of tokens.
